(19) United States
(12) Patent Application Publication
(10) Pub. No.: US 2026/0184953 A1
(43) Pub. Date: Jul. 2, 2026

(54) POLYCYCLIC-OLEFINIC POLYMERS CONTAINING EPOXY FUNCTIONALITY FOR FORMING LOW-LOSS FILMS HAVING IMPROVED THERMAL PROPERTIES

(71) Applicant: PROMERUS, LLC, AKRON, OH (US)

(72) Inventor: PRAMOD KANDANARACHCHI, AKRON, OH (US)

(73) Assignee: PROMERUS, LLC, AKRON, OH (US)

(21) Appl. No.: 19/437,988

(22) Filed: Dec. 31, 2025

Related U.S. Application Data
(60) Provisional application No. 63/740,747, filed on Dec. 31, 2024.

(51) Int. Cl. C09D 145/00; C08F 232/08; C09D 7/65

(52) U.S. Cl. CPC C09D 145/00; C08F 232/08; C09D 7/65; C08F 2800/10; C08F 2810/20

(57) ABSTRACT

Embodiments in accordance with the present invention encompass polymers of a variety of polycycloolefinic monomers at least one of which monomer contains an epoxy functional group. In further aspect of this invention there is provided an embodiment encompassing compositions containing the polymers of this invention, an epoxy crosslinker, a thermal acid generator and one or more suitable additives. The compositions of this invention can be formed into a variety of three-dimensional insulating articles upon exposure to suitable high temperature, such as for example films. The objects formed from the compositions of this invention exhibit hitherto unattainable low dielectric constant and low-loss properties, and very high thermal properties. The compositions of this invention may additionally contain one or more organic or inorganic filler materials, which provide improved thermo-mechanical properties in addition to very low dielectric properties. The compositions of this invention are useful in various applications, including as insulating materials in millimeter wave radar antennas, among others.

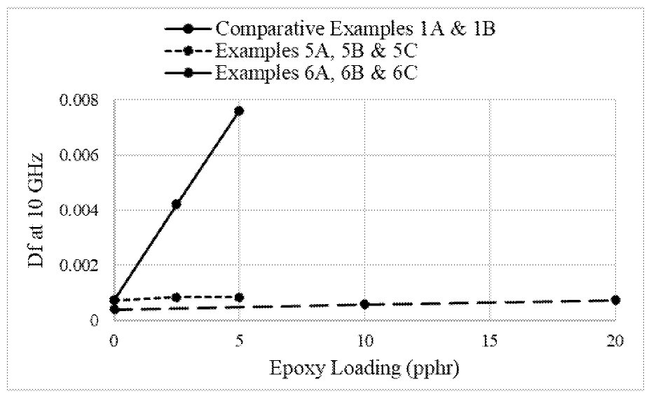

### CROSS REFERENCE TO RELATED APPLICATIONS

This application claims the benefit of U.S. Provisional Application No. 63/740,747 filed Dec. 31, 2024, which is incorporated herein by reference in its entirety.

### BACKGROUND OF THE INVENTION

### Field of the Invention

Embodiments in accordance with the present invention relate generally to polymers formed from two or more polycycloolefinic monomers at least one of which monomers containing an epoxy functionality. More specifically, this invention relates to a polymer containing two or more substituted norbornene derivatives among which at least one monomer contains at least one epoxy group. The embodiments of this invention further relate to compositions containing such polymers in combination with a suitable thermal acid generator and one or more additives. The compositions of this invention can readily be formed into films, which are useful as low loss thermosets and prepregs for copper clad laminates which not only exhibit low dielectric constant and low-loss properties but also very high thermal properties. For example, films formed from the compositions of this invention generally exhibit high glass transition temperature, which range from about 250° C. to 380° C., and also exhibit low dielectric constant (from about 2.2 to 2.5 at a frequency of 10 GHz), low dielectric dissipation factor (from about 0.0006 to 0.002 at a frequency of 10 GHz), and coefficient of thermal expansion (CTE) as low as 50 ppm/K. Accordingly, the polymers and composition of this invention find applications as insulating materials in a variety of applications including electromechanical devices having applications in the fabrication of a number of automotive parts, among others.

### Description of the Art

It is well known in the art that insulating materials having low dielectric constant (Dk) and low-loss, also referred to as dielectric dissipation factor (Df) are important in printed circuit boards catering to electrical appliances and automotive parts and other applications. Generally, in most of such devices the insulating materials that are suitable must have dielectric constant lower than 3 and low-loss lower than 0.002 at high frequencies such as for example greater than 10 GHz. Also, there is an increased interest in developing organic dielectric materials as they are easy to fabricate among other advantages.

However, the use of such materials in printed circuit boards as copper-clad laminates need high performance thermosets having high glass transition temperatures (T_{g}), low CTEs, low Dk/Df, high peel strength on copper and good reliability at high temperature storage. The ability to form prepreg (composite with glass cloth), B-staging capability (generate a layer of material that is not cross linked or partially cross linked) and film fusing capability for fabricating layered structures are also important. Most commercial materials available in the art have not attained all of these properties, especially low Dk/Df and high glass transition temperatures, higher than 200° C.

In addition, there are significant technical challenges in developing such insulating materials meeting all of the requirements. One such challenge is that such materials exhibit low coefficient of thermal expansion (CTE), which is as low as 50 ppm/K due to concerns of peeling from copper layers. Another challenge is that such materials exhibit very high glass transition temperature (T_{g}), which is generally greater than 150° C. or even higher than 250° C. due to the process conditions used in the manufacture of printed circuit boards as well as harsh conditions the devices may encounter, such as for example, millimeter-wave Radar antennas used in the automobiles and other terminal equipment in 5G devices.

Although films made from the addition polymerization of norbornene derivatives containing long side chains, such as for example, 5-hexylnorbornene (HexNB) and 5-decylnorbornene (DecNB) are known to have low Dk and Df due to their hydrophobic nature these films exhibit high CTE (>200 ppm/K) and low T_{g}. See, for example, JP 2016037577A and JP 2012121956A.

It has also been reported in the literature that certain of the polymers, such as for example, fluorinated poly-ethylene, poly-ethylene and poly-styrene feature low Dk/Df but all of such polymers are unsuitable as organic insulating materials as they exhibit very low glass transition temperatures, which can be much lower than 150° C. Further, it has also been reported in the literature that generally low CTE and high T_{g} polymers can be generated when certain substituted norbornenes substituted with polar groups such an ester or alcohol groups are incorporated. However, incorporation of such groups will increase both Dk and Df due to their polarizability under an electromagnetic field, particularly at high frequencies. Therefore, such polar group substituted norbornenes are unsuitable in forming insulating materials as contemplated herein.

U.S. Pat. No. 10,897,818 B2 discloses a composition containing modified polyphenylene ether containing vinyl benzyl end groups, a cross linker such as 1,3,5-triallyl-1,3,5-triazinane-2,4,6-trione, also known as triallyl isocyanurate (TAIC) and an epoxy compound. However, the compositions reported therein exhibit high Dk of about 3.7 and Df of about 0.005 albeit reasonably high T_{g} ranging from about 200-230° C.

Therefore, there is still a need to develop new insulating materials that exhibit not only low dielectric properties but also very high thermal properties.

In addition, there is also a need to develop materials, which can form thermoset films rather than thermoplastic films. That is, the thermosets are generally cross-linked structures, which are more stable to higher temperatures and do not exhibit any thermal mobility unlike thermoplastics.

Accordingly, it is an object of this invention to provide a polymer containing two or more monomers of substituted norbornenes, one of which monomer contains at least one epoxy functionality, and a composition derived therefrom which can be formed into an insulating material having hitherto unattainable properties.

Other objects and further scope of the applicability of the present invention will become apparent from the detailed description that follows.

### SUMMARY OF THE INVENTION

Surprisingly, it has now been found that employing a polymer containing one or more polycyclic olefinic monomer of formula (I) as described herein which contains an epoxy group and one or more polycyclic olefinic monomer of formula (II) as described herein, where a monomer of formula (I) is present at an amount not less than five mole percent based on total moles of monomers of formulae (I) and (II), it is now possible to form a polymer, which can be used in compositions as described herein to form a variety of three-dimensional objects, including films, which provide hitherto unattainable dielectric as well as thermal properties. Optionally, the polymer of this invention can also contain an additional third monomer of formula (III) as described herein.

In another aspect of this invention there is also provided a composition derived from the polymer of this invention.

In another aspect of this invention there is also provided a film, a composite, a prepreg comprising the composition of this invention.

### BRIEF DESCRIPTION OF THE DRAWINGS

Embodiments in accordance with the present invention are described below with reference to the following accompanying figures and/or images. Where drawings are provided, it will be drawings which are simplified portions of various embodiments of this invention and are provided for illustrative purposes only.

The drawing shows graphical plots of the effect of low loss properties with varied amounts of an epoxy crosslinker of a few of the exemplary compositions of this invention, which is compared with a comparative composition.

### DETAILED DESCRIPTION OF THE INVENTION

The terms as used herein have the following meanings:

As used herein, the articles “a,” “an,” and “the” include plural referents unless otherwise expressly and unequivocally limited to one referent.

Since all numbers, values and/or expressions referring to quantities of ingredients, reaction conditions, etc., used herein and in the claims appended hereto, are subject to the various uncertainties of measurement encountered in obtaining such values, unless otherwise indicated, all are to be understood as modified in all instances by the term “about.”

Where a numerical range is disclosed herein such range is continuous, inclusive of both the minimum and maximum values of the range as well as every value between such minimum and maximum values. Still further, where a range refers to integers, every integer between the minimum and maximum values of such range is included. In addition, where multiple ranges are provided to describe a feature or characteristic, such ranges can be combined. That is to say that, unless otherwise indicated, all ranges disclosed herein are to be understood to encompass any and all sub-ranges subsumed therein. For example, a stated range of from “1 to 10” should be considered to include any and all sub-ranges between the minimum value of 1 and the maximum value of 10. Exemplary sub-ranges of the range 1 to 10 include, but are not limited to, 1 to 6.1, 3.5 to 7.8, and 5.5 to 10, etc.

As used herein, “hydrocarbyl” refers to a group that contains carbon and hydrogen atoms, non-limiting examples being alkyl, cycloalkyl, aryl, aralkyl, alkaryl, and alkenyl. The term “halohydrocarbyl” refers to a hydrocarbyl group where at least one hydrogen has been replaced by a halogen. The term perhalocarbyl refers to a hydrocarbyl group where all hydrogens have been replaced by a halogen.

As used herein, the expression “alkyl” means a saturated, straight-chain or branched-chain hydrocarbon substituent having the specified number of carbon atoms. Particular alkyl groups are methyl, ethyl, n-propyl, isopropyl, tert-butyl, and so on. Derived expressions such as “alkoxy,” “thioalkyl,” “alkoxyalkyl,” “hydroxyalkyl,” “alkylcarbonyl,” “alkoxycarbonylalkyl,” “alkoxycarbonyl,” “diphenylalkyl,” “phenylalkyl,” “phenylcarboxyalkyl” and “phenoxyalkyl” are to be construed accordingly.

As used herein, the expression “cycloalkyl” includes all of the known cyclic groups. Representative examples of “cycloalkyl” includes without any limitation cyclopropyl, cyclobutyl, cyclopentyl, cyclohexyl, cycloheptyl, cyclooctyl, and the like. Derived expressions such as “cycloalkoxy,” “cycloalkylalkyl,” “cycloalkylaryl,” “cycloalkylcarbonyl” are to be construed accordingly.

As used herein, the expression “perhaloalkyl” represents the alkyl, as defined above, wherein all of the hydrogen atoms in said alkyl group are replaced with halogen atoms selected from fluorine, chlorine, bromine, or iodine. Illustrative examples include trifluoromethyl, trichloromethyl, tribromomethyl, triiodomethyl, pentafluoroethyl, pentachloroethyl, pentabromoethyl, pentaiodoethyl, and straight-chained or branched heptafluoropropyl, heptachloropropyl, heptabromopropyl, nonafluorobutyl, nonachlorobutyl, undecafluoropentyl, undecachloropentyl, tridecafluorohexyl, tridecachlorohexyl, and the like. Derived expression, “perhaloalkoxy,” is to be construed accordingly. It should further be noted that certain of the alkyl groups as described herein may partially be fluorinated, that is, only portions of the hydrogen atoms in said alkyl group are replaced with fluorine atoms and shall be construed accordingly.

As used herein the expression “acyl” shall have the same meaning as “alkanoyl,” which can also be represented structurally as “R—CO—,” where R is an “alkyl” as defined herein having the specified number of carbon atoms. Additionally, “alkylcarbonyl” shall mean same as “acyl” as defined herein. Specifically, “(C₁-C₄)acyl” shall mean formyl, acetyl or ethanoyl, propanoyl, n-butanoyl, etc. Derived expressions such as “acyloxy” and “acyloxyalkyl” are to be construed accordingly.

As used herein, the expression “aryl” means substituted or unsubstituted phenyl or naphthyl. Specific examples of substituted phenyl or naphthyl include o-, p-, m-tolyl, 1,2-, 1,3-, 1,4-xylyl, 1-methylnaphthyl, 2-methylnaphthyl, etc. “Substituted phenyl” or “substituted naphthyl” also include any of the possible substituents as further defined herein or one known in the art.

As used herein, the expression “arylalkyl” means that the aryl as defined herein is further attached to alkyl as defined herein. Representative examples include benzyl, phenylethyl, 2-phenylpropyl, 1-naphthylmethyl, 2-naphthylmethyl and the like.

As used herein, the expression “alkenyl” means a non-cyclic, straight, or branched hydrocarbon chain having the specified number of carbon atoms and containing at least one carbon-carbon double bond, and includes ethenyl and straight-chained or branched propenyl, butenyl, pentenyl, hexenyl, and the like. Derived expression, “arylalkenyl” and five membered or six membered “heteroarylalkenyl” is to be construed accordingly. Illustrative examples of such derived expressions include furan-2-ethenyl, phenylethenyl, 4-methoxyphenylethenyl, and the like.

As used herein, the expression “heteroaryl” includes all of the known heteroatom containing aromatic radicals. Representative 5-membered heteroaryl radicals include furanyl, thienyl or thiophenyl, pyrrolyl, isopyrrolyl, pyrazolyl, imidazolyl, oxazolyl, thiazolyl, isothiazolyl, and the like. Representative 6-membered heteroaryl radicals include pyridinyl, pyridazinyl, pyrimidinyl, pyrazinyl, triazinyl, and the like radicals. Representative examples of bicyclic heteroaryl radicals include, benzofuranyl, benzothiophenyl, indolyl, quinolinyl, isoquinolinyl, cinnolyl, benzimidazolyl, indazolyl, pyridofuranyl, pyridothienyl, and the like radicals.

As used herein, the expression “heterocycle” includes all of the known reduced heteroatom containing cyclic radicals. Representative 5-membered heterocycle radicals include tetrahydrofuranyl, tetrahydrothiophenyl, pyrrolidinyl, 2-thiazolinyl, tetrahydrothiazolyl, tetrahydrooxazolyl, and the like. Representative 6-membered heterocycle radicals include piperidinyl, piperazinyl, morpholinyl, thiomorpholinyl, and the like. Various other heterocycle radicals include, without limitation, aziridinyl, azepanyl, diazepanyl, diazabicyclo[2.2.1]hept-2-yl, and triazocanyl, and the like.

“Halogen” or “halo” means chloro, fluoro, bromo, and iodo.

In a broad sense, the term “substituted” is contemplated to include all permissible substituents of organic compounds. In a few of the specific embodiments as disclosed herein, the term “substituted” means substituted with one or more substituents independently selected from the group consisting of (C₁-C₆)alkyl, (C₂-C₆)alkenyl, (C₁-C₆)perfluoroalkyl, phenyl, hydroxy, —CO₂H, an ester, an amide, (C₁-C₆)alkoxy, (C₁-C₆)thioalkyl and (C₁-C₆)perfluoroalkoxy. However, any of the other suitable substituents known to one skilled in the art can also be used in these embodiments.

It should be noted that any atom with unsatisfied valences in the text, schemes, examples, and tables herein is assumed to have the appropriate number of hydrogen atom(s) to satisfy such valences.

It will be understood that the terms “dielectric” and “insulating” are used interchangeably herein. Thus, reference to an insulating material or layer is inclusive of a dielectric material or layer and vice versa. Further, as used herein, the term “organic electronic device” will be understood to be inclusive of the term “organic semiconductor device” and the several specific implementations of such devices used, for example, in automotive industry.

As used herein, the dielectric constant (Dk) of a material is the ratio of the charge stored in an insulating material placed between two metallic plates to the charge that can be stored when the insulating material is replaced by vacuum or air. It is also called as electric permittivity or simply permittivity. And, at times referred as relative permittivity, because it is measured relatively from the permittivity of free space.

As used herein, “low-loss” is the dissipation factor (Df), which is a measure of loss-rate of energy of a mode of oscillation (mechanical, electrical, or electromechanical) in a dissipative system. It is the reciprocal of quality factor, which represents the “quality” or durability of oscillation.

As used herein, “B-stage” means a material wherein the reaction between the base polymer and the curing agent/hardener is not complete. That is, such “B-staged” material is in a partially cured stage, and generally free of any solvent used to make the composition containing the base polymer and the curing agent/hardener. Generally, when such “B-staged” material is reheated at elevated temperature, the cross-linking is complete, and the material is fully cured.

As used herein, “prepreg” means a material that is pre-impregnated with a polymeric material which can be either a thermoplastic or a thermoset. Generally, a fibrous material such as glass cloth is pre-impregnated with a polymeric material to form prepregs, which is formed by a “B-stage” process and subsequently cured by reheating at elevated temperature.

By the term “derived” is meant that the polymeric repeating units are polymerized (formed) from, for example, polycyclic norbornene-type monomers in accordance with formulae (I) or (II) wherein the resulting polymers are formed by 2,3 enchainment of norbornene-type monomers as shown below:

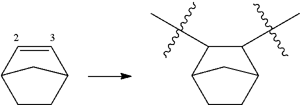

The above polymerization is also known widely as vinyl addition polymerization typically carried out in the presence of organometallic compounds such as organopalladium compounds or organonickel compounds as further described in detail below.

Thus, in accordance with the practice of this invention there is provided a polymer comprising:
a) at least one first repeating unit represented by formula (IA), said first repeating unit is derived from a monomer of formula (I):

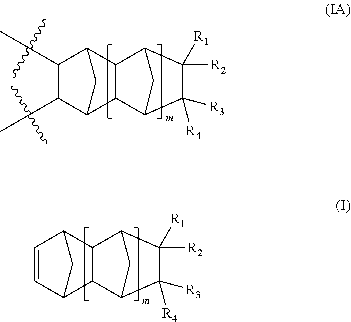

wherein:
[symbol] denotes a place of bonding with another repeat unit;
m is an integer 0, 1 or 2;
wherein at least one of R₁, R₂, R₃ and R₄ contains an epoxy group chosen from epoxy, —CH₂epoxy, epoxy(C₃-C₁₀)cycloalkyl, epoxy(C₆-C₁₂)bicycloalkyl, epoxy(C₆-C₁₂)aryl and epoxy(C₆-C₁₂)aryl(C₁-C₆)alkyl;
the remaining R₁, R₂, R₃ and R₄ are the same or different and each independently chosen from hydrogen, methyl, ethyl, linear or branched (C₃-C₁₆)alkyl, (C₃-C₁₀)cycloalkyl, (C₆-C₁₂)bicycloalkyl, (C₆-C₁₂)aryl and (C₆-C₁₂)aryl(C₁-C₆)alkyl; or
one of R₁ and R₂ taken together with one of R₃ and R₄ and the carbon atoms to which they are attached to form a substituted or unsubstituted (C₅-C₁₄)cyclic, (C₅-C₁₄)bicyclic or (C₅-C₁₄)tricyclic ring; and
b) at least one second repeating unit represented by formula (IIA), said second repeating unit is derived from a monomer of formula (II):

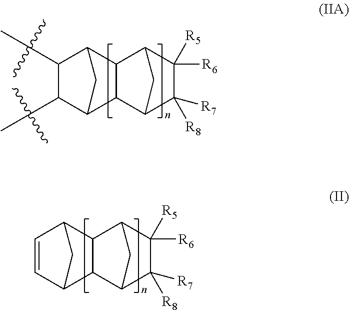

wherein:
[symbol] denotes a place of bonding with another repeat unit;
n is an integer 0, 1 or 2;
R₅, R₆, R₇ and R₈ are the same or different and each independently chosen from hydrogen, methyl, ethyl, linear or branched (C₃-C₁₆)alkyl, (C₃-C₁₀)cycloalkyl, (C₆-C₁₂)bicycloalkyl, (C₆-C₁₂)aryl and (C₆-C₁₂)aryl(C₁-C₆)alkyl; or
one of R₅ and R₆ taken together with one of R₇ and R₈ and the carbon atoms to which they are attached to form a substituted or unsubstituted (C₅-C₁₄)cyclic, (C₅-C₁₄)bicyclic or (C₅-C₁₄)tricyclic ring; and
c) optionally a third repeating unit represented by formula (IIIA), said third repeating unit is derived from a monomer of formula (III):

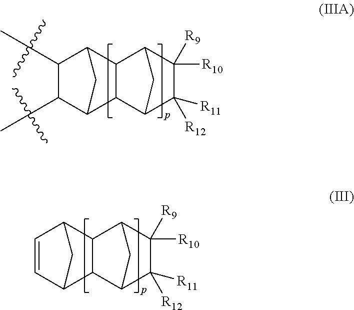

wherein:
[symbol] denotes a place of bonding with another repeat unit;
p is an integer 0, 1 or 2;
at least one of R₉, R₁₀, R₁₁ and R₁₂ is selected from the group consisting of methylidene, ethylidene, vinyl, linear or branched (C₃-C₁₆)alkenyl, (C₃-C₁₀)cycloalkenyl, (C₆-C₁₂)bicycloalkenyl and (C₆-C₁₂)aryl(C₂-C₁₆)alkenyl and the remaining R₉, R₁₀, R₁₁ and R₁₂ are the same or different and each independently selected from the group consisting of hydrogen, methyl, ethyl, linear or branched (C₃-C₁₆)alkyl, (C₃-C₁₀)cycloalkyl, (C₆-C₁₂)bicycloalkyl, (C₆-C₁₂)aryl and (C₆-C₁₂)aryl(C₁-C₆)alkyl; or one of R₉ and R₁₀ taken together with one of R₁ and R₁₂ and the carbon atoms to which they are attached to form a substituted or unsubstituted (C₅-C₁₄)cyclic, (C₅-C₁₄)bicyclic or (C₅-C₁₄)tricyclic ring containing at least one double bond; and
wherein the first repeat unit is present at an amount not less than five mole percent based on total moles of first, second and third, if present, repeat units.

The polymer as described herein can be prepared by any of the known vinyl addition polymerization methods in the art. It has now been found that the polymerization of one or more monomers of formula (I) with one or more monomers of formula (II) it is now possible to form polymers in accordance with this invention where the additional epoxy functionality present in monomer of formula (I) remains unreactive during vinyl addition polymerization and such epoxy functionality remains available in the polymer for other uses. Thus, the polymers of this invention can be used in a variety of applications where further crosslinking with other materials can be carried out. Such methods include formation of prepregs suitable in the fabrication of printed circuit boards, such as copper clad laminates. It has now been found that even incorporation of small amounts, as low as five mole percent of monomer of formula (I) it is now possible to form polymers in accordance with this invention which are quite effective in forming crosslinkable compositions of this invention as described in detail below.

Advantageously, it has now been found that the epoxy functionality present in the monomers of formula (I) is not reactive to the vinyl addition polymerization catalyst, and therefore remains present after formation of the polymer in accordance with this invention. That is, one of epoxy group present in R₁, R₂, R₃ or R₄ of the monomer of formula (I) remains available in the polymer formed in accordance with this invention. Therefore, the polymers of this invention are useful in a variety of applications where there is a need for further reaction involving the epoxy functionality, such as for example, crosslinking with other materials. It has been further observed that the amount of monomer of formula (I) employed can be as little as five (5) mole percent of the total amount of the combined monomers of formulae (I) and (II) in order to observe the crosslinking ability of the polymers of this invention.

Accordingly, in some embodiments the amount of repeat units of monomer of formula (IA) present in the polymer is at least five mole percent based on the total moles of first and second repeat units of formulae (IA) and (IIA). In some other embodiments the amount of repeat units of monomer of formula (IA) present in the polymer is from about six mole percent to about forty mole percent, from about ten mole percent to about thirty mole percent, from about fifteen mole percent to about twenty-five mole percent, and so on, based on the total moles of first and second repeat units of formulae (IA) and (HA). In yet some other embodiments the amount of repeat units of monomer of formula (IA) present in the polymer is from about six mole percent to thirty mole percent based on the total moles of first and second repeat units of formulae (IA) and (IIA).

As noted, more than one monomer of formula (II) with at least one monomer of formula (I) can be used to form the polymer of this invention. Advantageously, it has now been found that at least two distinctive monomers of formula (II) are employed with one monomer of formula (I). Again, any desirable amounts of distinctive monomers of formula (II) can be used in combination with a monomer of formula (I) as described herein. In some embodiments such molar ratios of distinctive monomers of formula (II) can be 10:90, 20:80, 30:70, 40:60, 50:50, and so on.

Similarly, more than one monomer of formula (I) with at least one monomer of formula (II) can be used to form the polymer of this invention. All such combinations are within the scope of this invention. For example, two distinctive monomers of formula (I) can be employed with one monomer of formula (II). Again, any molar ratios of distinctive two monomers of formula (I) can be employed, which include for example 10:90, 20:80, 30:70, 40:60, 50:50, and so on.

In some embodiments, the polymer according to this invention is having a repeat units of formula (IA) wherein m is 0 or 1. In some other embodiments, the polymer according to this invention is having a repeat units of formula (IA) wherein m is zero. That is, the repeat units of formula (IA) are derived from a monomer of formula (I), which is a derivative of norbornene. Again, one or more distinct monomers of formula (I) can be used to form the polymer of this invention. In some other embodiments the monomer of formula (I) employed is having m equals 1. That is, the monomer employed in this embodiment contains a dimeric norbornene monomer unit, which is also known as tetracyclodecene (TD). However, it should be noted that a combination of monomers of formula (I) having m=0 and m=1 can also be used to form the polymer of this invention. That is, a mixture of norbornene derivatives of formula (I) as described herein can be employed with a suitable tetracyclodecene derivative of formula (I) as described herein can be used to form the polymer of this invention. Again, any suitable amounts of these distinct monomers of formula (I) which will bring about the intended benefit can be employed to form the polymers of this invention. Accordingly, in some embodiments, the polymer according to this invention, encompasses the first repeat unit derived from two distinct monomers of formula (I).

Similarly, in some other embodiments, the polymer according to this invention is having a repeat units of formula (HA) wherein n is 0 or 1. In some other embodiments, the polymer according to this invention is having a repeat units of formula (HA) wherein n is zero. That is, the repeat units of formula (HA) are derived from a monomer of formula (II), which is a derivative of norbornene. Again, one or more distinct monomers of formula (II) can be used to form the polymer of this invention. In some other embodiments the monomer of formula (II) employed is having n equals 1. That is, the monomer employed in this embodiment contains a dimeric norbornene monomer unit, which is also known as tetracyclodecene (TD). However, it should be noted that a combination of monomers of formula (II) having n=0 and n=1 can also be used to form the polymer of this invention. That is, a mixture of norbornene derivatives of formula (II) as described herein can be employed with a suitable tetracyclodecene derivative of formula (II) can be used to form the polymer of this invention. Again, any suitable amounts of these distinct monomers which will bring about the intended benefit can be employed to form the polymers of this invention.

Accordingly, in some embodiments one of R₁, R₂, R₃ and R₄ is chosen from epoxy, epoxymethyl (—CH₂epoxy), cyclopentylepoxy, cyclohexylepoxy, cycloheptylepoxy, epoxyphenyl (styrene epoxide) and epoxybenzyl.

The remaining R₁, R₂, R₃ and R₄ are the same or different and each independently chosen from hydrogen, methyl, ethyl, n-propyl, n-butyl, n-hexyl, cyclopentyl, cyclohexyl and norbornyl.

In some other embodiments, the remaining one of R₁ and R₂ taken together with one of R₃ and R₄ and the carbon atoms to which they are attached to form a cyclopentyl, cyclohexyl, cycloheptyl, bicycloheptyl, bicyclooctyl, or adamantyl ring.

In yet some other embodiments, R₅, R₆, R₇ and R₈ are the same or different and each independently chosen from hydrogen, methyl, ethyl, n-propyl, n-butyl, n-hexyl, n-octyl, n-decyl, cyclopentyl, cyclohexyl, norbornyl, phenyl and phenethyl.

In some embodiments, one of R₅ and R₆ taken together with one of R₇ and R₈ and the carbon atoms to which they are attached to form a cyclopentenyl, cyclohexenyl, cycloheptenyl, bicycloheptenyl or bicyclooctenyl ring.

As noted, the polymer of this invention can additionally contain a third repeat unit of formula (IIIA) derived from a monomer of formula (III). Interestingly, it has now been found that the polymerization of one or more monomers of formula (I) with one or more monomers of formula (II) and optionally one or more monomers of formula (III) it is now possible to form polymers in accordance with this invention where the additional olefinic functionality present in monomer of formula (III) remains unreactive during vinyl addition polymerization along with the epoxy group of monomer of formula (I) and such olefinic and epoxy functionalities remain available in the polymer for other uses. Thus, such polymers of this invention provides further advantageous applications where such materials are needed. As noted, such applications may include formation of prepregs suitable in the fabrication of printed circuit boards, such as copper clad laminates, among other uses.

Accordingly, at least one of R₉, R₁₀, R₁₁ and R₁₂ is chosen from ethylidene, vinyl, propenyl, butenyl, pentenyl, hexenyl, heptenyl, octenyl, cyclopentenyl and cyclohexenyl, and the remaining R₉, R₁₀, R₁₁ and R₁₂ are the same or different and each independently chosen from hydrogen, methyl, ethyl, n-propyl, n-butyl, n-hexyl, cyclopentyl, cyclohexyl and norbornyl.

Again, any of the monomers of formula (I) within the scope of this invention can be employed to form the polymers of this invention. Non-limiting examples of such monomers of formula (I) may be chosen from:

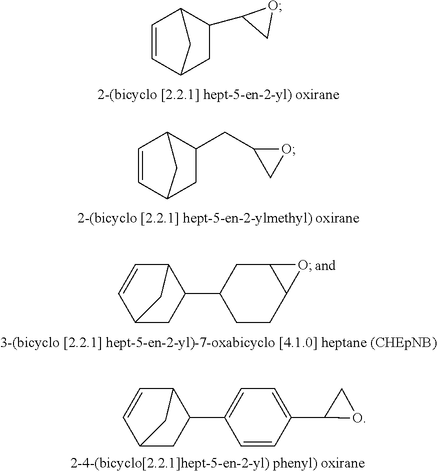 [SMILES: C1=CC2CC1CC2C1CO1 ; C1=CC2CC1CC2CC1CO1 ; C1=CC2CC1CC2C1CCC2OC2C1 ; C1=CC2CC1CC2c1ccc(C2CO2)cc1]

Similarly, any of the monomers of formula (II) within the scope of this invention can be employed to form the polymers of this invention. Non-limiting examples of such monomers of formula (II) may be chosen from:

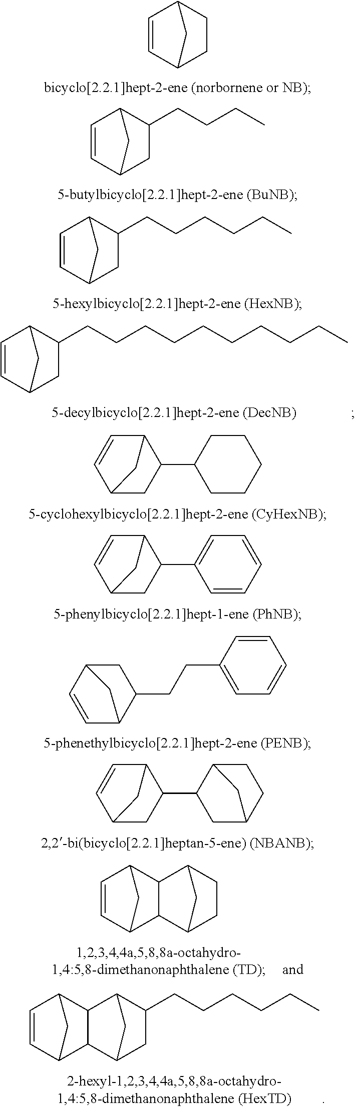

Similarly, any of the monomers of formula (III) within the scope of this invention can be employed to form the polymers of this invention. Non-limiting examples of such monomers of formula (III) may be chosen from:

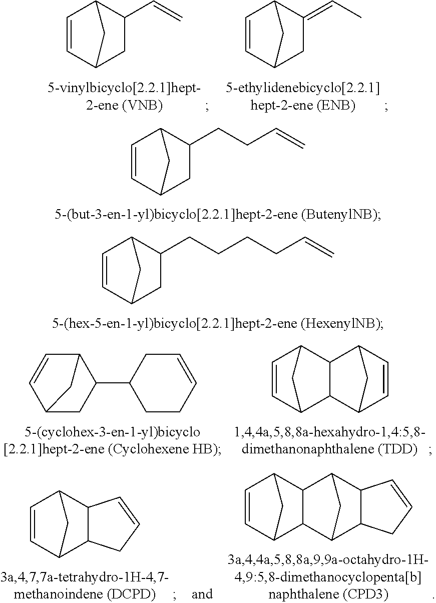

Exemplary non-limiting examples of polymer according to this invention may be enumerated as follows:
a terpolymer of norbornene (NB), 5-vinylbicyclo[2.2.1]hept-2-ene (VNB) and 3-(bicyclo[2.2.1]hept-5-en-2-yl)-7-oxabicyclo[4.1.0]heptane (CHEpNB);
a terpolymer of norbornene (NB), 5-(but-3-en-1-yl)bicyclo[2.2.1]hept-2-ene (ButenylNB) and 3-(bicyclo[2.2.1]hept-5-en-2-yl)-7-oxabicyclo[4.1.0]heptane (CHEpNB);
a terpolymer of 5-hexylbicyclo[2.2.1]hept-2-ene (HexNB), 5-(hex-5-en-1-yl)bicyclo[2.2.1]hept-2-ene (HexenylNB) and 3-(bicyclo[2.2.1]hept-5-en-2-yl)-7-oxabicyclo[4.1.0]heptane (CHEpNB);
a terpolymer of 5-phenethylbicyclo[2.2.1]hept-2-ene (PENB), 5-hexylbicyclo[2.2.1]hept-2-ene (HexNB) and 3.(bicyclo[2.2.1]hept-5-en-2-yl)-7-oxabicyclo[4.1.0]heptane (CHEpNB); and
a terpolymer of 5-hexylbicyclo[2.2.1]hept-2-ene (HexNB), 5-cyclohex-3-en-1-yl)bicyclo[2.2.1]hept-2-ene (CyclohexeneNB) and 2-(bicyclo[2.2.1]hept-5-en-2-yl)oxirane.

Surprisingly, it has now been observed that employing even amounts of about five mole percent of a monomer of formula (I) based on the total moles of monomers of formulae (I), (II) and (III), if present, it is now possible to form a polymer according to this invention which brings about effective crosslinking ability with other materials in forming a composite material having utility in a variety of applications as described hereinbelow. In some embodiments, the polymer according to this invention encompasses the first repeat unit of formula (IA), which is present at an amount in the range from about five mole percent to about thirty mole percent based on the total moles of first repeat unit(s) of formula (IA), second repeat unit(s) of formula (HA) and third repeat unit(s) of formula (IIA), if present. In some other embodiments, the polymer according to this invention encompasses the first repeat unit of formula (IA), which is present at an amount in the range from about ten mole percent to about twenty-five mole percent based on the total moles of first repeat unit(s) of formula (IA), second repeat unit(s) of formula (IIA) and third repeat unit(s) of formula (IIA), if present. In yet some other embodiments, the polymer according to this invention encompasses the first repeat unit of formula (IA), which is present at an amount in the range from about fifteen mole percent to about twenty mole percent based on the total moles of first repeat unit(s) of formula (IA), second repeat unit(s) of formula (IIA) and third repeat unit(s) of formula (IIIA), if present. However, it should be noted that in some embodiments the amount of repeat unit of formula (I) may be less than five mole percent or also can be higher than thirty mole percent depending upon the intended application. Accordingly, all such possible combinations of amounts that can be employed are well within the scope of this invention.

As noted, the monomers of formulae (I), (II) and (III), if present, undergo vinyl addition polymerization using any of the suitable catalysts known in the art. For example, various palladium compounds, platinum compounds as well as various nickel compounds have been used to form polymers of the types described herein. In some embodiments of this invention the polymer of this invention is formed by employing a palladium compound. Various palladium compounds known in the art can be employed. Non-limiting examples of such palladium compounds, including a few platinum compounds may be enumerated as follows:
palladium (II) bis(triphenylphosphine) dichloride;
palladium (II) bis(triphenylphosphine) dibromide;
palladium (II) bis(triphenylphosphine) diacetate;
palladium (II) bis(triphenylphosphine) bis(trifluoroacetate);
palladium (II) bis(tricyclohexylphosphine) dichloride;
palladium (II) bis(tricyclohexylphosphine) dibromide;
palladium (II) bis(tricyclohexylphosphine) diacetate (Pd785);
palladium (II) bis(tricyclohexylphosphine) bis(trifluoroacetate);
palladium (II) bis(tri-p-tolylphosphine) dichloride;
palladium (II) bis(tri-p-tolylphosphine) dibromide;
palladium (II) bis(tri-p-tolylphosphine) diacetate;
palladium (II) bis(tri-p-tolylphosphine) bis(trifluoroacetate);
palladium (II) ethyl hexanoate;
bis(acetonato)palladium (II);
dichloro bis(benzonitrile)palladium (II);
n-butyldi-1-adamantylphosphine palladium diacetate(H₂O) (Pd601);
n-butyldi-tert-butylphosphine palladium diacetate(H₂O) (Pd445);
bis(n-butyl-di-1-adamantylphosphine) palladium acetate(acetonitrile) tetrakis(pentafluorophenyl)borate (Pd1602); and
(acetonitrile)bis(triisopropylphosphine)palladium(acetate)tetrakis(pentafluorophenyl) borate (Pd1206);
[(allyl)palladium(trinaphthylphosphine)(trifluoroacetate)];
[(allyl)palladium(trinaphthylphosphine)(trifluoromethanesulfonate)];
platinum (II) chloride;
platinum (II) bromide; and
platinum bis(triphenylphosphine)dichloride.

It is also well known in the art that such palladium compounds are further activated using a variety of activator compounds. Non-limiting examples of such activators may be selected from the group consisting of:
lithium tetrafluoroborate;
lithium triflate;
lithium tetrakis(pentafluorophenyl)borate;
lithium tetrakis(pentafluorophenyl)borate etherate (LiFABA);
sodium tetrakis(pentafluorophenyl)borate etherate (NaFABA);
trityl tetrakis(pentafluorophenyl)borate etherate (tritylFABA);
tropylium tetrakis(pentafluorophenyl)borate etherate (tropyliumFABA);
lithium tetrakis(pentafluorophenyl)borate isopropanolate;
lithium tetraphenylborate;
lithium tetrakis(3,5-bis(trifluoromethyl)phenyl)borate;
lithium tetrakis(2-fluorophenyl)borate;
lithium tetrakis(3-fluorophenyl)borate;
lithium tetrakis(4-fluorophenyl)borate;
lithium tetrakis(3,5-difluorophenyl)borate;
lithium hexafluorophosphate;
lithium hexaphenylphosphate;
lithium hexakis(pentafluorophenyl)phosphate;
lithium hexafluoroarsenate;
lithium hexaphenylarsenate;
lithium hexakis(pentafluorophenyl)arsenate;
lithium hexakis(3,5-bis(trifluoromethyl)phenyl)arsenate;
lithium hexafluoroantimonate;
lithium hexaphenylantimonate;
lithium hexakis(pentafluorophenyl)antimonate;
lithium hexakis(3,5-bis(trifluoromethyl)phenyl)antimonate;
lithium tetrakis(pentafluorophenyl)aluminate;
lithium tris(nonafluorobiphenyl)fluoroaluminate;
lithium (octyloxy)tris(pentafluorophenyl)aluminate;
lithium tetrakis(3,5-bis(trifluoromethyl)phenyl)aluminate;
lithium methyltris(pentafluorophenyl)aluminate; and
dimethylanilinium tetrakis(pentafluorophenyl)borate (DANFABA).

Generally, the polymerization is carried out in a suitable solvent and at a suitable temperature. Any of the solvents that can solubilize the palladium compounds and the monomers employed or miscible with the liquid monomers can be employed for this purpose. Suitable polymerization solvents include without any limitation, alkane and cycloalkane solvents, such as pentane, hexane, heptane, decalin, cyclohexane and methyl cyclohexane; halogenated alkane solvents such as dichloromethane, chloroform, carbon tetrachloride, ethylchloride, 1,1-dichloroethane, 1,2-dichloroethane, 1-chloropropane, 2-chloropropane, 1-chlorobutane, 2-chlorobutane, 1-chloro-2-methylpropane, and 1-chloropentane; ethers such as THF and diethylether; aromatic solvents such as benzene, xylene, toluene, mesitylene, chlorobenzene, and o-dichlorobenzene; and halocarbon solvents such as Freon® 112; ester solvents such as methyl acetate, ethyl acetate, butyl acetate and amyl acetate; and mixtures in any combination thereof.

Any of the temperature conditions that will bring about such polymerization can be used herein. In some embodiments, the polymer of this invention is formed by heating a mixture containing suitable amounts of monomers of formulae (I) and (II) in the presence of a palladium compound and the activator as described herein at a temperature in the range of about 60° C. to about 150° C. for a sufficient length of time, for example from about one hour to eight hours. In some other embodiments, the monomer mixture with the catalyst is heated to a temperature of about 90° C. to about 130° C. for a sufficient length of time, for example from about one hour to four hours to form the polymer of this invention. Further, the solution polymerization is carried out under an inert atmosphere, such as for example, under nitrogen, helium or argon atmosphere and using anhydrous solvents.

Advantageously, the vinyl addition polymer is formed from a palladium compound and monomers of formulae (I) and (II) with very high conversion at low (for example 20,000-25,000 to 1) catalyst loading, where the polymer's molecular weight is controlled using a chain transfer agent, such as, triethylsilane (TES). Various other chain transfer agents can also be used to control the molecular weight of the resulting polymer as described herein, including for example, bicyclo[4.2.0]oct-7-ene (BCO), formic acid, various other silanes, and the like, including mixtures in any combination thereof. Use of various CTAs in vinyl addition polymerization in order to control the resulting polymer properties is well known in the art. See, for example, U.S. Pat. No. 9,771,443 B2, pertinent portions of which are incorporated herein by reference.

The polymers formed according to this invention generally exhibit a weight average molecular weight (M_{w}) of at least about 1,000. In another embodiment, the polymer of this invention has a M_{w} of at least about 3,000, 5,000, 10,000 or 20,000. In another embodiment, the polymer of this invention has a M_{w} of at least about 50,000. In another embodiment, the polymer of this invention has a M_{w} of at least about 60,000. In another embodiment, the polymer of this invention has a M_{w} of at least about 70,000. In yet another embodiment, the polymer of this invention has a M_{w} of at least about 80,000. In some other embodiments, the polymer of this invention has a M_{w} of at least about 100,000. In another embodiment, the polymer of this invention has a M_{w} of higher than 150,000, higher than 200,000 and can be higher than 500,000 in some other embodiments. The weight average molecular weight (M_{w}) of the polymer can be determined by any of the known techniques, such as for example, by gel permeation chromatography (GPC) equipped with suitable detector and calibration standards, such as differential refractive index detector calibrated with narrow-distribution polystyrene standards or polybutadiene (PBD) standards. The polymers of this invention typically exhibit polydispersity index (PDI) higher than 3, which is a ratio of weight average molecular weight (M_{w}) to number average molecular weight (Mₙ). In general, the PDI of the polymers of this invention ranges from 3 to 5. In some embodiments the PDI is higher than 3.5, higher than 4, higher than 4.5, or can be higher than 5. However, it should be noted that in some embodiments the PDI can be lower than 3, such as for example, 2.5.

The polymer thus formed is then used to make the compositions as described herein, which is used to produce composite materials having hitherto unattainable properties, such as for example, extremely low coefficient of thermal expansion (CTE), which can be as low as 100 ppm/° K, below 90 ppm/° K, 80 ppm/° K, 50 ppm/° K or lower than 40 ppm/° K. The polymer of this invention also exhibits extremely low dielectric constant as well as low loss properties. For example, dielectric constant (Dk) of the polymer of this invention can be as low as 2.5 or lower and can be in the range of from about 2.2 to about 2.5 at a frequency of 10 GHz. The low loss (Df) of the polymer can be lower than 0.0015, and may range from about 0.0006 to 0.002. In addition, the polymer of this invention exhibits extremely high glass transition temperature (T_{g}), which can be higher than 250° C., and generally ranges from about 250° C. to 380° C. Even more importantly, the polymer of this invention readily binds with other crosslinkable materials as illustrated further below in various compositions made according to this invention. The compositions thus formed exhibit excellent peel strength, generally ranging from 6 to 8 N/cm, thus finding many applications for example as copper clad laminates.

Accordingly, in a further aspect of this invention there is also provided a composition comprising:
a) a polymer made according to this invention;
b) one or more of an epoxy compound chosen from:

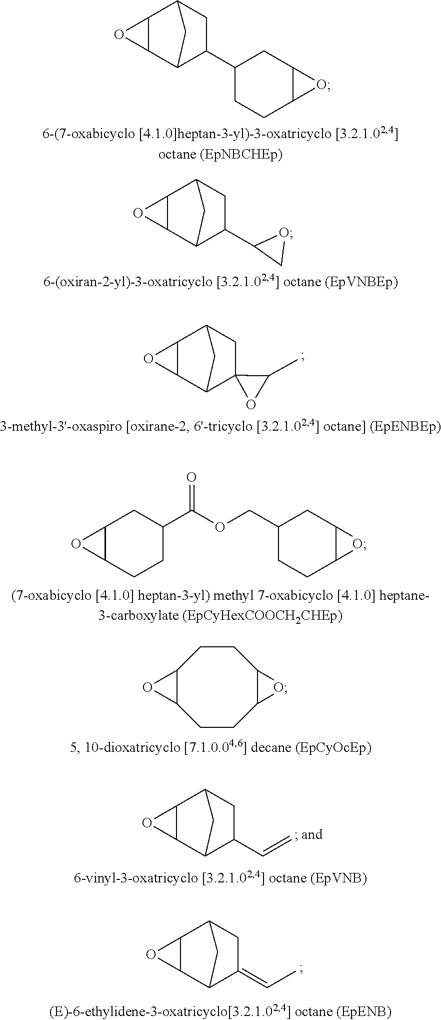

and
d) one or more additives chosen from a thermal acid generator or a free radical initiator.

The composition according to this invention can further contain a crosslinking agent chosen from:

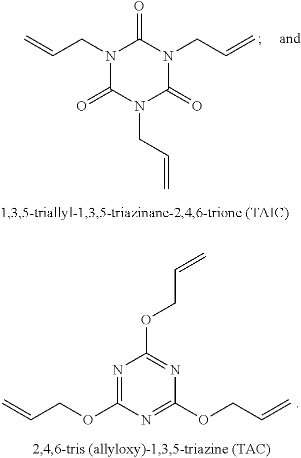

As noted, any of the specific polymers within the general scope as described herein derived from at least one monomer of formula (I) and one or more monomers of formula (II) can be employed in the composition of this invention. It should further be noted that the polymer contains at least five mole percent of repeat units of formula (IA) derived from the corresponding monomer of formula (I) based on the total moles of repeat units of formulae (IA) and (HA). In some embodiments, the composition of this invention contains a repeat units of formula (IA) derived from the corresponding monomer of formula (I) in the amounts ranging from about five (5) mole percent to about forty (40) mole percent, from about ten (10) mole percent to about thirty (30) mole percent, from about fifteen (15) mole percent to about twenty-five (25) mole percent, and so on, based on total mole percent of repeat units of formulae (IA) and (HA) present in the polymer. However, it should be noted that the polymer may contain lower than five (5) mole percent or higher than forty (40) mole of the repeat units of formula (IA) depending upon the intended application of the composition so formed. Accordingly, all such possible combinations of mole percent of repeat units of formula (IA) is within the scope of this invention.

It should be further noted that the composition of this invention can be formed from a polymer containing a third repeat unit of formula (IIIA) derived from a corresponding monomer of formula (III) as described herein.

As noted, the composition of this invention further contains a thermal acid generator. Any thermal acid generator which will bring about the crosslinking reaction with the polymer and other components present in the composition and which facilitates adhesion to other suitable substrate such as for example copper and/or glass cloth can be used in the composition of this invention.

Again, any amount of thermal acid generator can be used which will bring about the intended benefit. Such amounts may vary and for example can range from about 0.2 parts of thermal acid generator per hundred parts of polymer (pphr) to about 6 pphr of the thermal acid initiator. In some embodiments, such range can be from 0.3 pphr to 5 pphr, 0.4 pphr to 4 pphr, and so on.

Non-limiting examples of the thermal acid generator that can be used in the composition of this invention include the following:

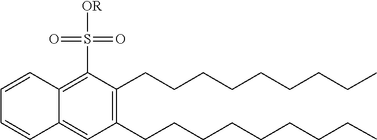

covalently blocked dinonylnaphthalene sulfonic acid ester, where R is (C₁-C₁₀)alkyl (DNNSA), available under the tradename NACURE® Catalysts from King Industries;

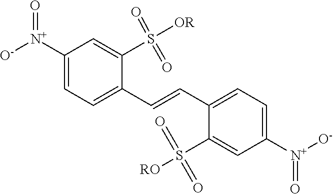

covalently blocked 4,4′-dinitrostilbene-2,2′-disulfonic acid ester, where R is (C₁-C₁₀)alkyl (DNNDSA), available under the tradename NACURE® Catalysts from King Industries;

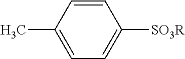

covalently blocked p-toluene sulfonic acid ester, where R is (C₁-C₁₀)alkyl (p-TSA);

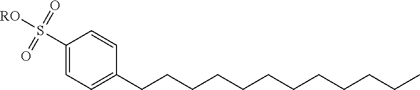

covalently blocked 4-dodecylbenzene sulfonic acid ester, where R is (C₁-C₁₀)alkyl (DDBSA), available under the tradename NACURE® Catalysts from King Industries;
dimethylanilinium tetrakis(pentafluorophenyl)borate (DANFABA); and
lithium tetrakis(pentafluorophenyl)borate diethyl etherate (LiFABA).

Any amount of the crosslinking agents, TAIC or TAC, either taken alone, or in combination, if needed, can be used in the composition of this invention so as to bring about the intended benefit. Accordingly, in some embodiments the composition contains only TAIC as the crosslinking agent. In some other embodiments the composition contains only TAC as the crosslinking agent. In yet some other embodiments the composition contains a mixture of both TAIC and TAC as the crosslinking agents. Generally, the amount of TAIC or TAC used alone in the composition of this invention can range from about 0 to 20 parts per hundred parts of polymer (pphr), 4 to 18 pphr, 10 to 16 pphr, and so on. When a combination of TAIC and TAC are used in the composition the amounts of each can be same or different. The total amount of TAIC and TAC may be around 10 to 30 pphr, 15 to 25 pphr, and so on. Again, it should be noted that such amounts can be higher or lower depending upon the intended use of the composition.

The composition according to this invention may additionally contain a tackifier. Generally, the purpose of the tackifier is not only to increase the adhesiveness of the composition but also to improve the softness of the composition especially while fabricating at temperatures higher than 130° C. so that the composition may have some flow to impregnate the glass cloth or to fuse with other layers of the device. The composition of this invention can generally be crosslinked at a temperature higher than 130° C., and it is beneficial to keep the composition soft at this temperature. Accordingly, any of the tackifiers that would bring about this benefit can be used in the compositions of this invention. In addition, the amount of tackifier used can also vary depending on the intended use. Generally, such amounts can range from about 0 to 30 parts per hundred parts of polymer (pphr), 4 to 25 pphr, 10 to 20 pphr, and so on. It should be noted that a combination of two or more tackifiers can also be used in the composition of this invention. In such situations the combined amount can be adjusted in order to provide the intended benefit.

Non-limiting examples of such tackifiers that are suitable in the composition of this may be enumerated as follows:

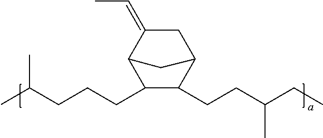

ethylene-propylene-ethylidenenorbornene terpolymer, where a is at least 100 (commercially available as TRILENE® T67 from Lion Elastomers);

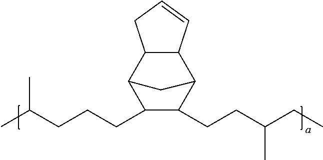

ethylene-propylene-dicyclopentadiene terpolymer, where a is at least 100 (commercially available as TRILENE® T65 from Lion Elastomers);

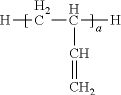

1,2-butadiene rubber, where a is at least 100 (commercially available as B1000 from Nisso America);

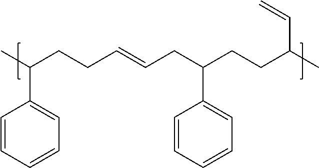

partially hydrogenated styrene/butadiene rubbers 1 (commercially available from Asahi Kasei as Tuftec P1083);

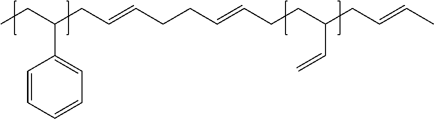

partially hydrogenated styrene/butadiene rubbers 2 (commercially available from Asahi Kasei as Tuftec 1500);

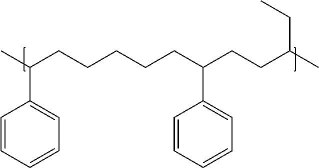

hydrogenated styrene/butadiene rubbers 1 (commercially available from Asahi Kasei as Tuftec H 105); and

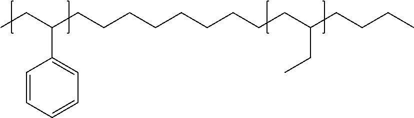

hydrogenated styrene/butadiene rubbers 2.

As noted, the composition of this invention may further contain a free radical generator. Any free radical generator which will bring about the crosslinking reaction with the polymer and other components present in the composition and which facilitates adhesion to other suitable substrate such as for example copper and/or glass cloth can be used in the composition of this invention. Again, any amount of free radical generator can be used which will bring about the intended benefit. Such amounts may vary and for example can range from about 0 pphr to 6 pphr of the free radical initiator.

Non-limiting examples of the free radical generator that can be used in the composition of this invention include the following:

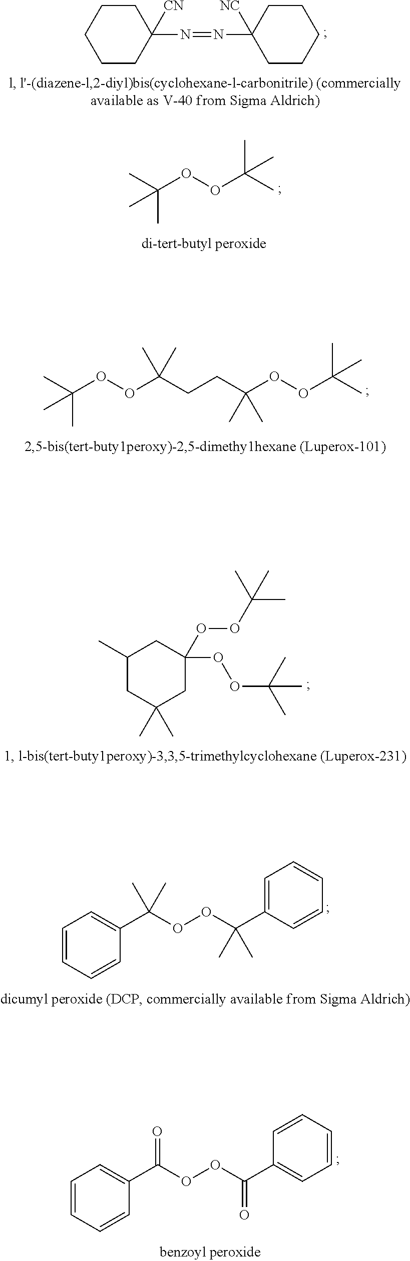

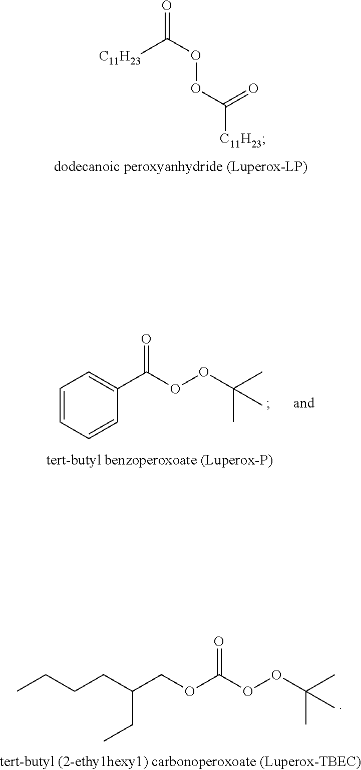

As noted, any of the polymers as described herein can be employed in the composition of this invention. Generally, the composition of this invention is dissolved in a suitable solvent to form a homogeneous solution. Such suitable solvents may be the same as the one enumerated above for forming the polymers of this invention. Generally, such solvents to form the composition of this invention include for example, aromatic solvents such as toluene, mesitylene, xylenes, hydrocarbon solvents such as decalin, cyclohexane and methyl cyclohexane, ether solvent such as tetrahydrofuran (THF), ester solvent such as ethyl acetate, and a mixture in any combination thereof.

Non-limiting examples of the composition according to this invention are selected from the group consisting of:
a solution containing a mixture of a terpolymer of 5-phenethylbicyclo[2.2.1]hept-2-ene (PENB), 5-hexylbicyclo[2.2.1]hept-2-ene (HexNB) and 3.(bicyclo[2.2.1]hept-5-en-2-yl)-7-oxabicyclo[4.1.0]heptane (CHEpNB); covalently blocked dinonylnaphthalene sulfonic acid (DNNSA), and 6-(7-oxabicyclo[4.1.0]heptan-3-yl)-3-oxatricyclo[3.2.1.0^{2,4}]octane (EpNBCHEp);
a solution containing a mixture of a terpolymer of 5-phenethylbicyclo[2.2.1]hept-2-ene (PENB), 5-hexylbicyclo[2.2.1]hept-2-ene (HexNB) and 3.(bicyclo[2.2.1]hept-5-en-2-yl)-7-oxabicyclo[4.1.0]heptane (CHEpNB); covalently blocked dinonylnaphthalene sulfonic acid (DNNSA), 6-(7-oxabicyclo[4.1.0]heptan-3-yl)-3-oxatricyclo[3.2.1.0^{2,4}]octane (EpNBCHEp) and lithium tetrakis(pentafluorophenyl)borate diethyl etherate (LiFABA);
a solution containing a mixture of a terpolymer of 5-phenethylbicyclo[2.2.1]hept-2-ene (PENB), 5-hexylbicyclo[2.2.1]hept-2-ene (HexNB) and 3.(bicyclo[2.2.1]hept-5-en-2-yl)-7-oxabicyclo[4.1.0]heptane (CHEpNB); covalently blocked dinonylnaphthalene sulfonic acid (DNNSA) and 6-(oxiran-2-yl)-3-oxatricyclo[3.2.1.0^{2,4}]octane (EpVNBEp); and
a solution containing a mixture of a terpolymer of 5-phenethylbicyclo[2.2.1]hept-2-ene (PENB), 5-hexylbicyclo[2.2.1]hept-2-ene (HexNB) and 3.(bicyclo[2.2.1]hept-5-en-2-yl)-7-oxabicyclo[4.1.0]heptane (CHEpNB); covalently blocked dinonylnaphthalene sulfonic acid (DNNSA) and 5,10-dioxatricyclo[7.1.0.0^{4,6}]-decane (EpCyOcEp).

In general, the composition in accordance with the present invention encompass a polymer as described herein containing at least one monomer of formula (I) in small quantities, and one or more distinct monomers of formula (II), as it will be seen below, various composition embodiments are selected to provide properties to such embodiments that are appropriate and desirable for the use for which such embodiments are directed, thus such embodiments are tailorable to a variety of specific applications. Accordingly, in some embodiments the composition of this invention encompasses a polymer containing more than one distinct monomers of formula (II), such as for example, two different monomers of formula (II) or three different monomers of formula (II) along with any desirable amount of monomer of formula (I), which can be as low as five mole percent as noted above; and optionally one or more monomers of formula (III).

For example, as already discussed above, by employing proper combination of different monomers of formula (II) it is now possible to tailor a composition having the desirable low dielectric properties and thermo-mechanical properties, among other properties. In addition, it may be desirable to include other polymeric or monomeric materials which are compatible to provide desirable low-loss and low dielectric properties depending upon the end use application as further discussed in detail below.

Even more advantageously, it has now been found that employing at least one monomer of formula (I), surprisingly, even in small amounts it is now possible to form crosslink structures within the polymeric framework in combination with the crosslinking agent as described herein. That is, crosslinks can occur inter-molecular (i.e., between two cross-linkable sites on different polymer chains as well as intra-molecular (i.e., between two cross-linkable sites on the same polymer chain). Statistically, this can happen, and all such combinations are part of this invention. By forming such inter-molecular or intra-molecular crosslinks the polymers formed from the composition of this invention provide hitherto unobtainable properties. This may include for example improved thermal properties. That is, much higher glass transition temperatures than observed for non-crosslinked polymers of similar composition. In addition, such crosslinked polymers are more stable at higher temperatures, which can be higher than 350° C. High temperature stability can also be measured by well-known thermogravimetric analysis (TGA) methods known in the art. One such measurement includes a temperature at which the polymer loses five percent of its weight (T_{d5}). As will be seen below by specific examples that follow the T_{d5} of the polymers formed from the composition of this invention can generally be in the range from about 310° C. to about 390° C. or higher. In some embodiments, the T_{d5} of the polymers formed from the composition of this invention is in the range from about 360° C. to about 380° C.

The compositions in accordance with the present invention may further contain optional additives as may be useful for the purpose of improving properties of both the composition and the resulting object made therefrom. Such optional additives for example may include anti-oxidants and synergists. Any of the anti-oxidants that would bring about the intended benefit can be used in the compositions of this invention. Non-limiting examples of such antioxidants include pentaerythritol tetrakis(3-(3,5-di-tert-butyl-4-hydroxyphenyl)propionate) (IRGANOX™ 1010 from BASF), 3,5-bis(1,1-dimethylethyl)-4-hydroxy-octadecyl ester benzenepropanoic acid (IRGANOX™ 1076 from BASF) and thiodiethylene bis[3-(3,5-di-tert.-butyl-4-hydroxy-phenyl)propionate](IRGANOX™ 1035 from BASF). Non-limiting examples of such synergists include certain of the secondary antioxidants which may provide additional benefits such as for example prevention of autoxidation and thereby degradation of the composition of this invention and extending the performance of primary antioxidants, among other benefits. Examples of such synergists include, tris(2,4-ditert-butylphenyl)phosphite, commercially available as IRGAFOS 168 from BASF, various diamine synergists such as for example, N,N′-di-2-naphthyl-1,4-phenylenediamine, among others. Another synergist which may be suitable as an additive in the composition of this include certain diesters, such as for example, didodecyl 3,3′-thiodipropionate, whose structure is shown below:

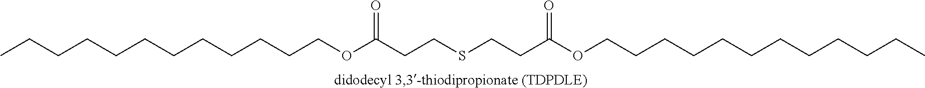 [SMILES: CCCCCCCCCCCCOC(=O)CCSCCC(=O)OCCCCCCCCCCCC]

Accordingly, the composition of this invention can be formed into films simply by following any of the known film casting techniques, including, for example, doctor blading, drum rolling, extrusion and/or spin coating, among other known methods. Accordingly, there is further provided a film formed from the composition of this invention. For example, any of the composition of this invention can be doctor-bladed onto a suitable substrate such as for example a glass plate. The coated plate is then heated to suitable temperature in an inert atmosphere to remove any residual solvent. Such temperatures can range from about 80° C. to 150° C. or 120° C. to 140° C. Suitable inert atmosphere can be nitrogen or argon. The heating at these temperatures for sufficient length of time will remove all of the residual solvent, for example a time interval of about 45 minutes to about 75 minutes. This initial stage of film forming is generally called as B-staged films. Under these conditions the film is still soluble in a suitable solvent such as for example THF, and is not fully crosslinked. The B-staged films are then further heated to higher temperature, which can range from about 150° C. to 220° C. or 160° C. to 190° C. in an inert atmosphere for sufficient length of time in order to affect the crosslinking of the film. Generally, such heating is carried out for about 90 minutes to 150 minutes to ensure full crosslinking of the composition, which is confirmed by insolubility of the polymer film.

The film thus formed in accordance with this invention exhibits unusually low dielectric constant, low loss, low coefficient of thermal expansion (CTE) and high glass transition temperature.

In some embodiments the film formed according to this invention exhibits a dielectric constant (Dk) less than 2.7, less than 2.6, less than 2.5, less than 2.4, less than 2.3, less than 2.2 at a frequency of 10 GHz, a glass transition temperature (T_{g}) in the range from about 150° C. to 280° C. or 250° C. to 300° C. or higher. In some other embodiments the T_{g} can be higher than 150° C., higher than 200° C., higher than 250° C., higher than 320° C. In yet some other embodiments the film according to this invention exhibits coefficient of thermal expansion (CTE) in the range of from about 50 ppm/K to 120 ppm/K, and a CTE less than 50 ppm/K when composited with glass cloth.

The film according to this invention can be formed from any of the specific embodiment of the composition as enumerated hereinabove. In a further aspect of this invention there is also provided a film formed from the polymer of this invention.

In a further embodiment, the film according to this invention exhibits a dielectric constant (Dk) less than 2.5 at a frequency of 10 GHz, a glass transition temperature higher than 300° C. and a coefficient of thermal expansion (CTE) less than 120 ppm/K.

It should additionally be noted that the crosslinked polymers formed from the composition of this invention may form thermosets thus offering additional advantages especially in certain applications where thermoplastics are not desirable. For example, any of the applications where higher temperatures are involved the thermoplastic polymers become less desirable as such polymeric materials may flow and are not suitable for such high temperature applications. Such applications include millimeter wave radar antennas as contemplated herein, among other applications.

Advantageously it has further been found that the low dielectric properties of the films formed from the composition of this invention can be improved by incorporating one or more filler materials. The filler materials can either be organic or inorganic. Any of the known filler materials which bring about the intended benefit can be used herein.

Accordingly, in some embodiments, the film forming composition according to this invention comprises an inorganic filler. Suitable inorganic filler is the one which has a coefficient of thermal expansion (CTE) lower than that of the film formed from the composition of this invention. Non-limiting examples of such inorganic filler includes oxides such as silica, alumina, diatomaceous earth, titanium oxide, iron oxide, zinc oxide, magnesium oxide, metallic ferrite; hydroxides such as aluminum hydroxide, magnesium hydroxide; calcium carbonate (light and heavy); magnesium carbonate, dolomite; carbonates such as doronite; sulfates such as calcium sulfate, barium sulfate, ammonium sulfate, and calcium sulfite; talc, mica; clay; glass fibers; calcium silicate; montmorillonite; silicates such as bentonite; borates such as zinc borate, barium metaborate, aluminum borate, calcium borate, and sodium borate; carbon black; carbon such as carbon fibers; iron powder; copper powder; aluminum powder; zinc oxide; molybdenum sulfide; boronic fibers; potassium titanate; and lead zirconate. Various inorganic filler materials are commercially available, for example, silica nano particles are available as SC2300-SVJ from Adamatech Co. Ltd., and a ceramic filler, Lithafrax-2121, is available from St. Gobain, among many other filler materials that may be suitable for using with the composition of this invention.

In some other embodiments the film forming composition according to this invention further comprises an organic filler, which is generally a synthetic resin maybe in the form of a powder or can be in any other suitable form or a polymer. Examples of such polymeric fillers include without any limitation, poly(α-methylstyrene), poly(vinyl-toluene), copolymers of α-methylstyrene and vinyl-toluene, and the like. Further examples of such synthetic resin powder include powders of various thermosetting resins or thermoplastic resins such as alkyd resins, epoxy resins, silicone resins, phenolic resins, polyesters, acrylic and methacrylic resins, acetal resins, polyethylene, polyethers, polycarbonates, polyamides, polysulfones, polystyrenes, polyvinyl chlorides, fluororesins, polypropylene, ethylene-vinyl acetate copolymers, and powders of copolymers of these resins. Other examples of the organic filler include aromatic or aliphatic polyamide fibers, polypropylene fibers, polyester fibers, aramid fibers, and the like.

In some embodiments the filler is an inorganic filler. Thus, the coefficient of thermal expansion can be effectively reduced. Further, heat resistance can be improved. Accordingly, in some embodiments the inorganic filler is silica. Thus, the thermal expansion coefficient can be reduced while the dielectric characteristic is improved. Various forms of silica fillers are known in the art and all of such suitable silica fillers can be used in the composition of this invention. Examples of such silica filler include without any limitation fused silica, including fused spherical silica and fused crushed silica, crystalline silica, silica nano particles, and the like. In some embodiments the filler employed is silica nano particles. Surprisingly, it has now been observed that by employing suitable amounts of silica nano particles it is now possible to form composition which exhibits very low dielectric constant and very low loss properties. In some embodiments, by employing suitable silica nanoparticles in the amounts of about 60 pphr to 80 pphr, the dielectric constant (Dk) can be reduced to as low as 2.25 or lower and low loss (Df) of about 0.0009. In some other embodiments the Dk is 2.3 and Df is about 0.001. Generally, the amount of filler material can vary from about 5 weight percent to 80 weight percent or higher. In some embodiments, the content of the filler in the composition is from about 30 to 80 weight percent, based on the total solid content of the composition when polymerized to form film/sheet as described herein. By appropriately adjusting the content of the filler, the balance between the dielectric property and the coefficient of thermal expansion (CTE) can be improved. In some other embodiments, the content of the filler in the composition is from about 40 to 70 weight percent, based on the total solid content of the composition.

In general, the filler is treated with a silane compound having an alkoxysilyl group and an organic functional group such as an alkyl group, an epoxy group, a vinyl group, a phenyl group and a styryl group in one molecule. Such silane compounds include, for example, a silane having an alkyl group such as ethyltriethoxysilane, propyltriethoxysilane or butyltriethoxysilane (alkylsilane), a silane having a phenyl group such as phenyltriethoxysilane, benzyltriethoxysilane or phenethyltriethoxysilane, a silane having a styryl group such as styryltrimethoxysilane, butenyltriethoxysilane, propenyltriethoxysilane or vinyltrimethoxysilane (vinylsilane), a silane having an acrylic or methacrylic group such as γ-(methacryloxypropyl) trimethoxysilane, a silane having an amino group such as γ-aminopropyltriethoxysilane, N-β (aminoethyl)-γ-aminopropyltrimethoxysilane, N-phenyl-γ-aminopropyltrimethoxysilane or an epoxy group such as γ-(3,4-epoxycyclohexyl) ureido triethoxysilane, and the like. Silanes having a mercapto group such as γ-mercaptopropyltrimethoxysilane or the like can also be used. It should further be noted that one or more of the aforementioned silane compounds can be used in any combination.

It should further be noted that, when an inorganic filler is used as the filler, the filler is generally treated with a “nonpolar silane compound.” Thus, the adhesion between the cyclic olefin polymer formed from the composition of this invention and the filler can be improved. As a result, the mechanical characteristics of the molded body can be improved. Advantageously, it has now been observed that treatment with a “nonpolar silane compound” can eliminate or reduce adverse effects on dielectric properties. As used herein, “nonpolar silane compound” refers to a silane compound having no polar substituent. Polar substituents refer to groups that can be hydrogen-bonded or ionically dissociated. Such polar substituents include, but are not limited to, —OH, —COOH, —COOM, NH₃, NR₄⁺ A⁻, —CONH₂, and the like. Where, M is a cation such as an alkali metal, an alkaline earth metal or a quaternary ammonium salt, R is H or an alkyl group having 8 or less carbon atoms, and A is an anion such as a halogen atom.

In some embodiments, the surface of the filler is modified with a vinyl group. It is advantageous to employ a vinyl group as it is a non-polar substituent, thus providing much needed low dielectric properties. In order to modify the surface of the filler with a vinyl group, for example, vinylsilane can be used. Specific examples of the vinylsilane are as described hereinabove.

In general, the average particle size of the filler used is in the range from about 0.1 to 10 m. In some embodiments, it is from about 0.3 to 5 m, and in some other embodiments it is from about 0.5 to 3 m. The average particle size is defined as the average diameter of the particles as measured by the light scattering method. When more than one type of filler is used, the average particle diameter of one or more of such fillers is still within the aforementioned numerical range. Since the average particle diameter of the filler is suitably small, the specific surface area of the filler is reduced. As a result, the number of polar functional groups which may adversely affect the dielectric properties is reduced, and the dielectric properties are easily improved. In addition, when the average particle diameter of the filler is suitably small, it is easy to polymerize and form the films from the composition of this invention. Even more importantly, the films/sheets so formed exhibit much needed uniform thickness and flatness as is needed in many of the intended applications.

The composition of the present invention may contain components other than those described above. The components other than the above include a coupling agent, a flame retardant, a release agent, an antioxidant, and the like. Non-limiting examples of the coupling agent include, silane coupling agents, such as, vinylsilanes, acrylic and methacrylic silanes, styrylsilanes, isocyanatosilanes, and the like. Adhesion between the composition of this invention and a base material or the like can be improved by using a silane coupling agent.

Non-limiting examples of the flame retardant include a phosphorus-based flame retardant such as trixylenyl phosphate, dixylenyl phosphate, 10-(2,5-dihydroxyphenyl)-10H-9-oxa-10 phosphaphenanthrene-10-oxide, a halogen-based flame retardant such as a brominated epoxy resin, and an inorganic flame retardant such as aluminum hydroxide and magnesium hydroxide.

The composition of this invention may further include one or more compounds or additives having utility as, among other things, adhesion promoter, a surface leveling agent, a synergist, plasticizers, curing accelerators, and the like.

Surprisingly, it has now been found that employing one or more thermal free radical initiator as described herein it is now possible to accelerate the crosslinking of the polymer formed from the composition of this invention, resulting in a crosslinked polymer that exhibits much improved thermal properties. For example, both glass transition temperature (T_{g}) and temperature at which five weight percent weight loss occurs (T_{d5}) of the resulting polymer can be increased. Such increase in T_{g} can be substantial and can range from about 10° C. to 50° C. In some embodiments the T_{g} of the polymer is increased from 20° C. to 40° C. by employing suitable amounts of thermal free radical initiator. Similarly, the T_{d5} of the polymer can also be increased from about 3° C. to 10° C.

It should be noted that the composition of this invention can be formed into any shape or form and not particularly limited to film. Accordingly, in some embodiments the composition of this invention can be formed into a sheet. The thickness of the sheet is not particularly limited, but when the application as a dielectric material is considered, the thickness is, for example, 0.01 to 0.5 mm. In some other embodiments the thickness is from about 0.02 to 0.2 mm. The sheet so formed generally does not substantially flow at room temperature (25° C.). The sheet may be provided on an arbitrary carrier layer or may be provided alone. Examples of the carrier layer include a polyimide film or a glass sheet. Any other known peelable film substrates may be used as the carrier layer.

As described above, the film/sheet formed in accordance with this invention has good dielectric properties and can be tailored based on the types of components employed in the composition of this invention as described herein. In quantitative terms, the relative permittivity, i.e., the dielectric constant (Dk) of the film/sheet at a frequency of 10 GHz is from about 2.2 to 2.8. The dielectric loss tangent (Df) at a frequency of 10 GHz is from about 0.0004 to 0.002, and in some other embodiments it is from about 0.0009 to 0.0015. As a result, the composition of the present invention finds applications in a variety of devices where such low dielectric materials are needed, such as for example, the dielectric polymeric layers used in the millimeter wave radar antenna used in automotive applications and various other terminal equipment used in 5G devices, among others. See for example, JP 2018-109090 and JP 2003-216823. An antenna is usually composed of an insulator and a conductor layer (for example, copper foil). The composition or sheet of the present invention can be used as a part or the whole of the insulator. The antenna using the composition or the sheet of the present invention as a part or the whole of the insulator has good high-frequency characteristics and reliability (durability). The use of such materials in printed circuit boards as Cu-clad laminates need high performance thermosets having high glass transition temperatures, low coefficients of thermal expansion (CTE), low Dk/Df, high peel strength on Cu and good reliability at high temperature storage. The ability to form prepreg (composite with glass cloth), B-staging capability (generate a layer of material that is not cross linked or partially cross linked) and film fusing capability for fabricating layered structures are also important. Most commercial materials available in this area have not attained all these properties, especially low Dk/Df and high glass transition temperature.

The conductor layer in the antenna is formed of, for example, a metal having desirable conductivity. A circuit is formed on the conductor layer by using a known circuit processing method. Conductors forming the conductor layer include various metals having conductivity, such as gold, silver, copper, iron, nickel, aluminum, or alloy metals thereof. As a method for forming the conductor layer, a known method can be used. Examples include vapor deposition, electroless plating, and electrolytic plating. Alternatively, the metal foil (for example, copper foil) may be pressure-bonded by thermocompression bonding. The metal foil constituting the conductor layer is generally a metal foil used for electrical connection. In addition to the copper foil, various metal foils such as gold, silver, nickel, and aluminum can be used. It may also comprise an alloy foil substantially (for example, 98 wt % or more) composed of these metals. Among these metal foils, a copper foil is commonly used. The copper foil may be either a rolled copper foil or an electrolytic copper foil.

Advantageously, the composition of this invention fills the gap not hitherto attainable by the prior art materials. That is, as noted above, the compositions of this invention not only exhibit much needed low Dk/Df properties but also provides very high thermally stable materials as demonstrated by very high T_{g} and very high T_{d5} properties as discussed hereinabove.

Even more importantly the compositions of this invention can be formed into films/sheets of desirable thickness for forming various prepregs with glass cloth for fabricating into copper clad laminates. In some embodiments the film thickness of the films formed from the composition of this invention can be in the range of from about 75 to 150 microns, 90 to 120 microns suitable for forming metal clad laminates. In some embodiments the thickness can be lower than 75 microns or higher than 150 microns.

It should further be noted that various dielectric materials used in the applications mentioned herein must also withstand very harsh temperature conditions and must retain their dielectric properties for a long duration of time. Surprisingly, the films formed in accordance with this invention retain such low dielectric properties for a long period of time of up to 1000 hours or longer even when kept at high temperatures of about 125° C. or higher, thus providing additional benefit. The change of Dk or Df is very low, which can be as low as 3 percent or as low as one percent. Accordingly, in some embodiments of this invention the films formed in accordance with this invention retain substantially their Dk/Df properties for a period of 1000 hours or more at a temperature in the range of about 120° C. to 150° C. or higher.

As noted, the composition of this invention is generally used as such to form a film or sheet. In addition, the composition of this invention can also be used as a low molecular weight varnish-type material for certain applications. The weight average molecular weight of the polymer used in such application can be as low as 1,000 or 2,000 or 3,000 or can be less than 10,000. In such applications suitable amount of the desirable solvents can be added so as to maintain the solid content of the composition to about 10 to 70 weight percent when polymerized. Again, any of the solvents that are suitable to form such solutions can be used as a single solvent or a mixture of solvents as is needed for such application.

In a further aspect of this invention there is provided a kit for forming a film. There is dispensed in this kit a composition of this invention. Accordingly, in some embodiments there is provided a kit in which there is dispensed a polymer as described herein, one or more epoxy crosslinking agents as described herein, a thermal acid generator as described herein, and if needed, a tackifier, a free radical generator as described herein; and one or more optional additives as described herein. In some embodiments the kit of this invention contains a polymer having a repeat unit of formula (IA) derived from a monomer of formula (I) and two distinct repeat units of formula (IIA) derived from the respective monomers of formula (II) in combination with at least one of an epoxy compound as described herein and a thermal acid generator as described herein, and if needed, one each of a tackifier, a free radical generator and an optional additive so as to obtain a desirable result and/or for intended purpose.

In another aspect of this embodiment of this invention the kit of this invention forms B-stageable film when subjected to suitable temperature for a sufficient length of time. That is to say that the composition of this invention is poured onto a surface or onto a substrate which needs to be encapsulated and exposed to suitable thermal treatment in order for the composition to undergo crosslinking to form a fully cured material which is in the form of a film, or a sheet as described herein.

Generally, as already noted above, such curing/crosslinking can take place at various temperature conditions, such as for example heating, which can also be in stages, for example heating to 90° C., then at 110° C., and finally at 150° C. for sufficient length of time, for example 5 minutes to 2 hours at each temperature stage for removing the solvents. The B-staged film can be further heated to higher than 150° C., for example to 180° C. for various lengths of time such as from 90 minutes to 150 minutes so as to cure the film to form a crosslinked polymeric network. By practice of this invention, it is now possible to obtain polymeric films on such substrates which are substantially uniform films. The thickness of the film can be as desired and as specifically noted above, and may generally be in the range of 50 to 500 microns or higher.

While making a sheet and to secure the flatness of the sheet and suppressing unintended shrinkage, various heating methods known to make sheet materials may be employed. For example, it is possible to heat at a relatively low temperature at first, and then gradually raise the temperature. In order to ensure flatness or the like, heating may be performed by pressurizing with a flat plate (metal plate) or the like before heating and/or by pressurizing with a flat plate. The pressure used for such pressurization may be, for example, 0.1 to 8 MPa, and in some other embodiments it may range from about 0.3 to 5 MPa.

In some embodiments, the kit as described herein encompasses various exemplary compositions as described hereinabove.

In yet another aspect of this invention there is further provided a method of forming a film for the fabrication of a variety of optoelectronic and/or automotive devices comprising:
forming a homogeneous clear composition comprising a polymer as described herein; one or more epoxy compound as described herein; a thermal acid generator, and if needed, a tackifier as described herein; a free radical initiator as described herein; and optionally one or more additives, including a filler as described herein;
coating a suitable substrate with the composition or pouring the composition onto a suitable substrate to form a film; and
heating the film in stages to a suitable temperature to cause formation of the B-stageable film and a cured film.

The coating of the desired substrate to form a film with the composition of this invention can be performed by any of the coating procedures as described herein and/or known to one skilled in the art, such as by spin coating. Other suitable coating methods include without any limitation spraying, doctor blading, meniscus coating, ink jet coating and slot coating. The mixture can also be poured onto a substrate to form a film. Suitable substrates include any appropriate substrate as is, or may be used for electrical, electronic, or optoelectronic devices, for example, a semiconductor substrate, a ceramic substrate, a glass substrate.

Next, the coated substrate is baked, i.e., heated to facilitate the removal of solvent and cross linking, for example to a temperature from 50° C. to 150° C. for about 1 to 180 minutes, although other appropriate temperatures and times can be used. That is, first forming the film by a B-stage process to remove any solvent present and then partially curing, and in a subsequent step at a higher temperature fully curing. In some embodiments the substrate is baked at a temperature of from about 100° C. to about 120° C. for 120 minutes to 180 minutes. In some other embodiments the substrate is baked at a temperature of from about 110° C. to about 140° C. for 60 minutes to 120 minutes. That is, these are the B-staged films. Finally, the B-staged films thus formed are further heated to temperatures higher than about 150° C., for example, 180° C. to fully cure the film.

The films thus formed are then evaluated for their electrical properties using any of the methods known in the art. For example, the dielectric constant (Dk) or permittivity and dielectric loss tangent at a frequency of 10 GHz was measured using a device for measuring the permittivity by the cavity resonator method (manufactured by AET, conforming to JIS C 2565 standard). The coefficient of thermal expansion (CTE) was measured using a thermomechanical analysis apparatus (made by Seiko Instruments, SS 6000) in accordance with a measurement sample size of about 4 mm (width)×40 mm (Length)×0.1 mm (thickness), a measurement temperature range of 30˜350° C., and a temperature rising rate of 5° C./min. The coefficient of linear expansion from 50° C. to 100° C. was adopted as the coefficient of linear expansion. Generally, the films formed according to this invention exhibit excellent dielectric and thermal properties and can be tailored to desirable dielectric and thermal properties as described herein.

Accordingly, in some of the embodiments of this invention there is also provided a film or sheet obtained by the polymer or the composition as described herein. In another embodiment there is also provided a glass composite film or sheet obtained by the polymer or the composition as described herein. In another embodiment there is also provided an electronic device comprising the film/sheet of this invention as described herein.

The composition of this invention can also be formed into a variety of composite structures which can be used as prepreg materials in the fabrication of metal clad laminates. Various types of metals can be used for this purpose, including for example copper, aluminum, stainless steel, among others. Metal clad lamination is well known in the art where layers of metal are cladded with insulation materials, such as for example the composition of this invention. For example, the compositions of this invention can be impregnated onto a glass fabric and then formed into a prepreg in a B-stage process by heating to suitable temperatures as described herein. Then the prepregs thus formed are sandwiched between layers of copper or other metal foil and cured at a temperature higher than 150° C. to form copper clad laminates.

It has now been found that the laminates thus formed in accordance with this invention exhibits excellent peel strength. That is, the cured films of this invention are so strongly bonded to either the glass surface or the metal surface it is difficult to peel the film from such substrates. Even more advantageously, it has now been surprisingly found that the peel strength can be increased by using optimum levels of the thermal acid generator or the free radical initiator, if employed. For example, use of very low levels, i.e., less than 0.5 pphr of the thermal acid generator can result in the composition exhibiting unacceptable peel strength. Whereas use of thermal acid generator in the range of about 2 to 3 pphr can provide surprisingly excellent peel strength. Accordingly, in some embodiments the peel strength of the composites formed in accordance with this invention can range from about 5 N/cm to about 8 N/cm or 9 N/cm or 11 N/cm or 13 N/cm or even higher depending upon the optimal amounts of free radical initiator used therein and the type of composite that is being made.

Accordingly, in some embodiments there is provided a glass cloth composite film/cloth (i.e., a prepreg) formed from the polymer or the composition of this invention, which exhibits a dielectric constant (Dk) less than 2.5 at a frequency of 10 GHz, a peel strength higher than 6 N/cm and a coefficient of thermal expansion (CTE) less than 50 ppm/K.

Advantageously, it has been further observed that the compositions of this invention can be coated uniformly onto a variety of glass or metal surfaces before curing such that any voids in the surface of such materials are fully covered. Then the coated surface is cured at a higher temperature to form a fully cured insulating layer, which is firmly bonded to such glass or metal surface. That is, for example, it is now possible to provide a metal foil with a coating of this composition to produce a printed wiring board or metal clad laminate in which the adhesion property between the insulating layer (i.e., the film formed from the composition of this invention), and the metal layer is excellent, and the loss at the time of signal transmission is further reduced.

Even more advantageously, it has now been found that the composition of this invention when applied onto a suitable surface can still flow and fill the voids before the two layers are well bonded. This is especially advantageous in the fabrication of metal clad laminates such as copper clad laminates where it is essential that all voids are completely insulated so as to further minimize loss at the time of signal transmission. Accordingly, in one aspect of this invention there is provided a method for producing a prepreg or a metal-clad laminate where a suitable glass fabric or a metal foil is coated with a composition of this invention and heated to suitable temperature in the range of from about 80° C. to 120° C. to form an uncured film of the composition of this invention on such glass fabric and/or metal foil. The composites thus formed are then cured at a higher temperature in the range of from about 160° C. to 200° C. to form fully cured laminates. It should particularly be noted that the polymers used in this aspect of the invention can be of very low molecular weight. That is, the weight average molecular weight (M_{w}) of the polymers employed in this aspect of the invention can be as low as 1,000 or can be in the range from about 1,000 to 5,000. The compositions of this invention exhibit excellent flow properties before they are fully cured and fill the surfaces uniformly on such glass fabric or metal foil, thus providing excellent insulating layer exhibiting very low dielectric constant and low loss properties as described herein.

The following examples are detailed descriptions of methods of preparation and use of certain compounds/monomers, polymers, and compositions of the present invention. The detailed preparations fall within the scope of, and serve to exemplify, the more generally described methods of preparation set forth above. The examples are presented for illustrative purposes only, and are not intended as a restriction on the scope of the invention. As used in the examples and throughout the specification the ratio of monomer to catalyst is based on a mole-to-mole basis.

### EXAMPLES (GENERAL)

The following abbreviations have been used hereinbefore and hereafter in describing some of the compounds, instruments and/or methods employed to illustrate certain of the embodiments of this invention:
NB—bicyclo[2.2.1]hept-2-ene; HexNB—5-hexylbicyclo[2.2.1]hept-2-ene; BuNB—5-butylbicyclo[2.2.1]hept-2-ene; PENB—5-phenethylbicyclo[2.2.1]hept-2-ene; CyHexeneNB—5-(cyclohex-3-en-1-yl)bicyclo[2.2.1]hept-2-ene; VNB—5-vinylbicyclo[2.2.1]hept-2-ene; ENB—5-ethylidenebicyclo[2.2.1]hept-2-ene; CHEpNB—3-(bicyclo[2.2.1]hept-5-en-2-yl)-7-oxabicyclo[4.1.0]heptane; Pd785—palladium (II) bis(tricyclohexylphosphine) diacetate; Pd1206-(acetonitrile)bis(triisopropylphosphine)palladium(acetate)-tetrakis(pentafluorophenyl)borate; Pd601—palladium diacetate diadamantyl-(n-butyl)phosphine(H₂O); Pd1602—[Pd(OAc)(MeCN)(PAd₂-n-Bu)₂]B(C₆F₅)₄; DANFABA—dimethylanilinium tetrakis(pentafluorophenyl)borate; LiFABA—lithium tetrakis(pentafluorophenyl)borate diethyl etherate; NACURE-1419—a covalently blocked dinonylnaphthalenesulfonic acid; TAIC—1,3,5-triallyl-1,3,5-triazinane-2,4,6-trione; TAC—2,4,6-tris(allyloxy)-1,3,5-triazine; V-40-1,1′-(diazene-1,2-diyl)bis(cyclohexane-1-carbonitrile); DCP—dicumyl peroxide; B1000—1,2-butadiene rubber; T65—ethylene-propylene-dicyclopentadiene terpolymer; T67—ethylene-propylene-ethylidenenorbornene terpolymer; SA9000—poly-aryl ether cross linker end capped with methacrylate groups; SC2300-SVJ—silica nano particles; Irganox-1076-3,5-bis(1,1-dimethylethyl)-4-hydroxy-octadecyl ester benzenepropanoic acid; Irgafos-168—tris(2,4-ditert-butylphenyl)phosphite; BCO—bicyclo[4.2.0]oct-7-ene; TES—triethylsilane; EA—ethyl acetate; THF—tetrahydrofuran; IPA—isopropanol; MCH—methyl cyclohexane; UV-CATA—bis-4,4′-(C₁₀-C₁₃)alkylphenyl-iodonium tetrakis(pentafluorophenyl)borate; ITX—2-isopropyl-9H-thioxanthen-9-one; GPC—gel permeation chromatography; M_{w}—weight average molecular weight; Mₙ—number average molecular weight; PDI—polydispersity index; NMR—nuclear magnetic resonance spectroscopy; DSC—differential scanning calorimetry; TGA—thermogravimetric analysis; TMA—thermomechanical analysis; pphr—parts per hundred parts resin by weight, i.e., the polymer according to this invention or the monomer mixture as specifically described hereinbelow.

Various monomers as used herein are either commercially available or can be readily prepared following the procedures as described in U.S. Pat. No. 9,944,818.

### Example A

### 6-(7-Oxabicyclo[4.1.0]heptan-3-yl)-3-oxatricyclo[3.2.1.0^{2,4}]octane (EpNBCHEp)

A mixture of CHEpNB (4 g, 22 mmol) and sodium bicarbonate (NaHCO₃, 8.4 g, 100 mmol) were mixed in distilled water (40 g), acetone (12 g) and methylene chloride (40 g). Oxone (KHSO₅·0.5HSO₄·0.5K₂SO₄, 8.45 g, 27.5 mmol) was dissolved in distilled water (50 g) and added slowly to the above mixture while maintaining the temperature of the reaction mixture below 30° C. The reaction mixture was continued to stir at ambient temperature overnight (about 16 hours). The organic layer was separated and washed with distilled water (2×100 g), dried over anhydrous magnesium sulfate, filtered and rotary evaporated to remove the solvent. About 3 g (69% yield) of an oily product was obtained. GC-MS analysis of this product indicated the presence of the title compound (m/z=206.2) at about 81% GC area ratio and the starting CHEpNB at about 19% area ratio. ¹H NMR analysis of the product confirmed the GC analysis (2.8-3.3 ppm for protons connected to epoxy groups and 5.6-6.2 ppm for the protons of the double bond of the starting material). This product was used as a cross linker without further purification.

### Example B

6-(Oxiran-2-yl)-3-oxatricyclo[3.2.1.0^{2,4}]octane (EpVNBEp) A mixture of VNB (2 g, 17 mmol) and sodium bicarbonate (NaHCO₃, 14.3 g, 170 mmol) were mixed in distilled water (75 g), acetone (25 g) and methylene chloride (75 g). Oxone (KHSO₅·0.5HSO₄·0.5K₂SO₄, 26.2 g, 42.5 mmol) was dissolved in water (100 g) and added slowly to the above mixture while maintaining the temperature of the reaction mixture below 30° C. The reaction mixture was allowed to stir at ambient temperature for about 5 hours. The organic layer was separated and washed with distilled water (3×100 g), dried over anhydrous magnesium sulfate, filtered and rotary evaporated to remove the solvent. About 1.6 g (63% yield) of an oily product was obtained. GC-MS analysis of this product indicated the presence of the title compound (m/z=152.1) at about 64% GC area ratio and the starting VNB at about 33% area ratio. ¹H NMR analysis of the product confirmed the GC analysis (2.8-3.3 ppm for protons connected to epoxy groups and 4.8-5.1 ppm and 5.6-5.8 ppm for the protons of the double bond of the starting material). This product was used as a cross linker without further purification.

### Example C

### 3-methyl-3′-oxaspiro[oxirane-2,6′-tricyclo[3.2.1.0^{2,4}]octane](EpENBEp)

A mixture of ENB (3 g, 25 mmol) and sodium bicarbonate (NaHCO₃, 21.5 g, 260 mmol) were mixed in distilled water (100 g), acetone (40 g) and methylene chloride (110 g). Oxone (KHSO₅·0.5HSO₄·0.5K₂SO₄, 39.2 g, 64.0 mmol) was dissolved in water (150 g) and added slowly to the above mixture while maintaining the temperature of the reaction mixture below 30° C. The reaction mixture was allowed to stir at ambient temperature for about 5 hours. The organic layer was separated and washed with distilled water (3×100 g), dried over anhydrous magnesium sulfate, filtered and rotary evaporated to remove the solvent. About 2 g (52% yield) of an oily product was obtained. GC-MS analysis of this product indicated the presence of the title compound (m/z=152.1) at about 85% GC area ratio and the starting ENB (m/z=136.1) at about 6% area ratio. ¹H NMR analysis of the product confirmed the GC analysis (2.8-3.5 ppm for protons connected to epoxy groups). This product was used as a cross linker without further purification.

### Example D

### 5,10.Dioxatricyclo[7.1.0.0^{4,6}]decane (EpCyOcEp)

The title compound was prepared in accordance with the procedure set out in Org. Lett. 2018, 20, 7172-7176. Cycloocta-1,5-diene (10.8 g) was dissolved in acetone. To this solution was added NaHCO₃ (84 g). The mixture was then cooled to 0° C. Oxone (KHSO₅·0.5HSO₄·0.5K₂SO₄, 154 g) dissolved in water (˜800 mL) was added dropwise to the cooled mixture. After the Oxone addition, the mixture was stirred at room temperature overnight. The reaction mixture was extracted with tert-butyl methyl ether (3×250 mL). The combined ether layer was washed with brine (1×500 mL) and then dried over Na₂SO₄. The solvent was removed in vacuo and 1.41 g (10% yield) of title compound as clear oil was obtained. ¹H NMR (500.2 MHz, CDCl₃): 3.03-300 (m, 4H), 2.06-2.01 (m, 4H), 1.94-1.90 (m, 4H). The NMR spectroscopy of the resulting material matched previously published data for this compound.

### Polymer Example 1

### Terpolymer of NB/VNB/CHEpNB (70/20/10 Molar Ratio)

A mixture of NB (49.4 g, 525 mmol as 75 wt. % solution in toluene), VNB (18 g, 150 mmol), CHEpNB (14.3 g, 75 mmol), TES (39.3 g, 338 mmol), ethanol (3.46 g, 75 mmol) and DANFABA (0.18 g, 0.225 mmol dissolved in anhydrous toluene (536 g) were placed in a glass reactor and flushed with nitrogen. This solution was heated to 80° C. To this solution was added Pd1206 (0.09 g, 0.075 mmol as a 2.1 wt. % solution in anhydrous EA) by syringe transfer. The heating of the mixture at 80° C. while stirring was continued for 4 hours. The polymerized mixture was diluted with toluene and added to excess IPA to precipitate out the solid polymer. The solid was dried in an oven at 50-80° C. under vacuum for about 16 hours to obtain the dry polymer at about 75% isolated yield. GPC (THF): M_{w}=9,700, Mₙ=2,300, PDI=4.18). Polymer composition calculated by ¹H NMR (CDCl₃) NB/VNB/CHEpNB, 73/16/11.

### Polymer Example 2

### Terpolymer of NB/VNB/CHEpNB (75/20/5 Molar Ratio)

A mixture of NB (127.1 g, 1350 mmol as 75 wt. % solution in toluene), VNB (43.3 g, 360 mmol), CHEpNB (17.1 g, 90 mmol), TES (94.2 g, 810 mmol), ethanol (8.29 g, 180 mmol) and DANFABA (0.43 g, 0.540 mmol dissolved in anhydrous toluene (1188 g) were taken in a glass reactor and flushed with nitrogen. This solution was heated to 80° C. To this solution was added Pd-1206 (0.22 g, 0.180 mmol as a 0.5 wt. % solution in anhydrous ethyl acetate) by syringe transfer. The heating of the mixture at 80° C. while stirring was continued for 4 hours. The polymerized mixture was concentrated to about 50 wt. % and then diluted to about 38 wt. % with cyclohexane and added to excess (about 2.3 L) IPA to precipitate out the solid polymer. The solid was dried in an oven at 50-80° C. under vacuum for about 16 hours to obtain the dry polymer at about 95% isolated yield. GPC (THF): M_{w}=4,700, Mₙ=900, PDI=5.21). Polymer composition calculated by ¹H NMR (CDCl₃) NB/VNB/CHEpNB, 78/16/6.

### Polymer Example 3

### Terpolymer of NB/PENB/CyHexeneNB (60/20/20 Molar Ratio)

A mixture of NB (101.7 g, 1080 mmol as 75 wt. % solution in toluene), PENB (71.4 g, 360 mmol), CyHexeneNB (62.7 g, 360 mmol), TES (1.99 g, 17.1 mmol) and LiFABA (0.32 g, 0.36 mmol dissolved in anhydrous toluene (9.5 g) were placed in a glass reactor and flushed with nitrogen. This solution was heated to 80° C. to this solution was added Pd601 (0.072 g, 0.120 mmol in a 1.7 wt. % solution in anhydrous THF) by syringe transfer. The heating of the mixture at 80° C. while stirring continued for 4 hours. The polymer solution was diluted with toluene to make about 11 wt. % solution and added to excess IPA (about 6 Kg) to separate the solid polymer. The isolated solid was dried at 50-80° C. under vacuum for about 16 hours to obtain the final polymer at about 87% isolated yield. GPC (THF): M_{w}=85,550, Mₙ=32,850, PDI=2.60). Polymer composition calculated by ¹H NMR (CDCl₃) NB/PENB/CyHexeneNB, 60/19/21.

### Polymer Example 4

### Terpolymer of PENB/HexNB/CHEpNB (70/22.5/7.5 Molar Ratio)

A mixture of PENB (11.1 g, 56 mmol), HexNB (3.2 g, 18 mmol), CHEpNB (1.14 g, 6 mmol), BCO (0.07 g, 0.6 mmol) and LiFABA (0.008 g, 0.1 mmol as 4.8 wt. % solution in ethyl acetate) and toluene (46 g) were dissolved in a glass bottle, flushed with nitrogen and sealed. This solution was heated to 90° C. To this solution was added Pd785 (0.003 g, 0.003 mmol in a 1.2 wt. % solution in methyl cyclohexane) by syringe transfer. The heating of the mixture at 90° C. while stirring continued for 20 hours. The polymer solution was added to excess IPA to separate the solid polymer. The isolated solid was dried at about 80° C. under vacuum for about 16 hours to obtain the final polymer (14.1 g, 91% isolated yield). GPC (THF): M_{w}=87,000, Mₙ=22,250, PDI=3.91).

### Polymer Example 5

### Terpolymer of PENB/HexNB/CHEpNB (70/20/10 Molar Ratio)

A mixture of PENB (11.1 g, 56 mmol), HexNB (2.85 g, 16 mmol), CHEpNB (1.52 g, 6 mmol), BCO (0.07 g, 0.6 mmol) and LiFABA (0.008 g, 0.01 mmol as 4.8 wt. % solution in ethyl acetate) and toluene (46 g) were dissolved in a glass bottle, flushed with nitrogen and sealed. This solution was heated to 90° C. To this solution was added Pd785 (0.003 g, 0.003 mmol in a 1.2 wt. % solution in methyl cyclohexane) by syringe transfer. The heating of the mixture at 90° C. while stirring continued for 20 hours. The polymer solution was added to excess IPA to separate the solid polymer. The isolated solid was dried at about 80° C. under vacuum for about 16 hours to obtain the final polymer (10 g, 65% isolated yield). GPC (THF): M_{w}=71,100, Mₙ=24,600, PDI=2.89).

### Polymer Example 6

### Terpolymer of PENB/HexNB/CHEpNB (50/35/15 Molar Ratio)

A mixture of PENB (7.92 g, 40 mmol), HexNB (4.98 g, 28 mmol), CHEpNB (2.28 g, 12 mmol), BCO (0.07 g, 0.6 mmol) and LiFABA (0.008 g, 0.01 mmol as 4.8 wt. % solution in ethyl acetate) and toluene (46 g) were dissolved in a glass bottle, flushed with nitrogen and sealed. This solution was heated to 90° C. To this solution was added Pd785 (0.003 g, 0.003 mmol in a 1.2 wt. % solution in methyl cyclohexane) by syringe transfer. The heating of the mixture at 90° C. while stirring continued for 20 hours. The polymer solution was added to excess IPA to separate the solid polymer. The isolated solid was dried at about 80° C. under vacuum for about 16 hours to obtain the final polymer (14.4 g, 95% isolated yield). GPC (THF): M_{w}=100,400, Mₙ=19,150, PDI=5.25).

### Flame Test Measurements

The flame retardancy of the compositions of this invention was measured using this procedure. The rectangular test samples of about 1 cm×10 cm and the thicknesses ranging from 500-800 μm were placed vertically on a tip of a propane flame of about 2 cm high. The sample was allowed to burn for 10 seconds and removed from the flame. The time to extinguish the burning sample (after flame time t₁) was noted. The same sample was placed on the flame again and allowed to burn for 10 seconds and removed from the flame. The time to extinguish the burning sample (after flame time t₂) was noted. If both t₁ and t₂ are 10 seconds or less, samples self-extinguished, and any dripping flames did not cause a cotton pad placed beneath the flame to catch fire, the UL94 rating for the sample was deemed V0. If both t₁ and t₂ are 30 seconds or less, samples self-extinguished, and any dripping flames did not cause a cotton pad placed beneath the flame to catch fire, the UL94 rating for the sample was deemed V1. If both t₁ and t₂ are 60 seconds or less, samples self-extinguished, and any dripping flames did not cause a cotton pad placed beneath the flame to catch fire, the UL94 rating for the sample was deemed 5VA.

### Peel Strength Measurements

The peel strength of a variety of flame retardant compositions of this invention was measured using this test procedure. The flame retardant compositions of this invention, for example flame retardant compositions containing melamine was coated on copper foil surface using a doctor blade to prepare about 300 μm coating. The solvent was removed by heating to 110° C. in an oven under nitrogen inlet and outlet for 30 minutes. A low loss glass cloth was sandwiched between two such coatings and heated to 150° C. for 1 hour while pressing to about 5 MPa using two metal plates of a heated press. For peel strength measurements, an ADMET Peel Strength Test Fixture having a pneumatic clamp of 250 N capacity was utilized in combination with an Instron Mdl. 5564 tensile tester. Rectangular samples of approximately 1.5 cm×6 cm were mounted on a plate using double-sided tape, and the copper foil tab was attached to the clamps in the instrument. The copper foil tab was pulled out of the sample at 5 mm/min rate at a 90° tilt while the average load of the peaks and troughs were registered. The peel strengths of the laminated films on Cu surface at 90-deg tilt were measured by the highest 5 peaks method for the rectangular laminate of about 1.5 cm width.

### Dielectric Measurements

Dielectric constants (Dₖ) and dielectric dissipation factors (D_{f}) of a variety of compositions of this invention such as for example glass cloth composites with thicknesses ranging from 125-200 μm were measured at 10 GHz using a 2-part Vector Network Analyzer (300 kHz-14 GHz) from Keysight Technologies, Inc. 2020 Model P9373A using the resonance cavity method.

### Examples 1A-1D

### Dielectric and Thermal Properties of Low Loss Films and Composites Generated by Mass Polymerization

Pd785 was dissolved in MCH to prepare 1 wt. % solution and DANFABA was dissolved in anhydrous EA to prepare 5 wt. % solution. A monomer mixture of BuNB and CHEpNB were mixed with Pd785 and DANFABA solutions in desirable amounts as listed in Table 1. The mass polymerization mixtures had about 7-8 wt. % solvents (MCH/EA) and had monomers:Pd-785:DANFABA molar ratio of about 10000:1:5. Optionally, silica nano particles (SV2300-SVJ from Admatechs Co. Ltd.) were dispersed into the monomer and catalyst mixtures as summarized in Table 1. The amounts of silica particles dispersed are expressed as parts per hundred parts of the total monomer weight (pphm). These compositions were doctor bladed on glass substrates and heated to 110° C. under nitrogen atmosphere for 3 hours to affect polymerization of the monomers and then the temperature was increased to 180° C. under nitrogen atmosphere and kept for 2 hours to affect the epoxy curing of the polymers by the epoxy groups contained in CHEpNB. Films having thicknesses in the range of 150-250 μm were obtained. Dielectric constant (Dₖ) and dielectric dissipation factor (D_{f}) were measured at 10 GHz. Coefficient of thermal expansion (CTE) and glass transition temperature (T_{g}) were measured by TMA. The temperature at which 5 wt. % of the film is lost (T_{d5}) was measured by TGA. The results are summarized in Table 1.

TABLE 1

| Example | BuNB | CHEpNB | Silica | | | T_{g} | CTE | T_{d5} |
|---|---|---|---|---|---|---|---|---|
| No. | (Mole %) | (Mole %) | (pphm) | Dₖ | D_{f} | (° C.) | (ppm/K) | (° C.) |
| Example 1A | 90 | 10 | — | 2.23 | 0.0011 | 361 | 111 | 315 |
| Example 1B | 90 | 10 | 40 | 2.46 | 0.0017 | 361 | 61 | 391 |
| Example 1C | 80 | 20 | — | — | — | 308 | 89 | 290 |
| Example 1D | 80 | 20 | 40 | 2.46 | 0.0016 | 388 | 64 | 394 |

### Examples 2A-2C

### Low Loss Properties of Cured Films of Terpolymer and NACURE-19

A terpolymer, PENB/HexNB/CHEpNB (50/35/15 mole ratio), as set forth in Polymer Example 6 was dissolved in mesitylene to prepare 25 wt. % solution. NACURE-1419 catalyst was dissolved in mesitylene to deliver this thermal acid generator to the polymer solution at various loadings as summarized in Table 2. The polymer solutions containing this thermal acid catalyst was doctor bladed on glass substrates and heated to 130° C. for 1 hour in an oven under nitrogen atmosphere to remove the solvent. The films obtained were fully cured at 180° C. for 1 hour in an oven under nitrogen atmosphere to obtain films at 150-250 μm thicknesses. The solubilities of the films in THF after the solvent removal (initial solubility) and after fully cured (final solubility) and dielectric properties of the fully cured films were determined at 10 GHz and are summarized in Table 2.

TABLE 2

| | NACURE- | Initial | Final | | |
|---|---|---|---|---|---|
| Example No. | 1419 loading | Solubility | Solubility | Dₖ | D_{f} |
| Example 2A | 0.3 pphr | Yes | Partial | — | 0.0013 |
| Example 2B | 0.5 pphr | Yes | Partial | 2.19 | 0.0013 |
| Example 2C | 1.0 pphr | Yes | Partial | 2.29 | 0.0013 |
| Example 2D | 3.0 pphr | Yes | No | 2.28 | 0.0014 |

### Examples 3A-3D

### Low Loss Properties of Cured Films of Terpolymer and EpNBCHEp as Epoxy Crosslinker

A terpolymer, PENB/HexNB/CHEpNB (50/35/15 mole ratio) as set forth in Polymer Example 6 was dissolved in mesitylene to prepare 25 wt. % solution. NACURE-1419 catalyst was dissolved in mesitylene and LiFABA was dissolved in EA to deliver these thermal acid generators to the polymer solution at various loadings as summarized in Table 3. The epoxy cross linker, EpNBCHEp, of Example A was also added to Examples 3C and 3D in various quantities as summarized in Table 3. The polymer solutions containing thermal acid catalysts and epoxy cross linkers were doctor bladed on glass substrates and heated to 130° C. for 1 hour in an oven under nitrogen atmosphere to remove the solvent. The films obtained were fully cured at 180° C. for 1 hour in an oven under nitrogen atmosphere. The dielectric properties of the fully cured films were determined at 10 GHz and the results are summarized in Table 3. Since the fully cured film of the Example 3A was very brittle, its dielectric properties were measured only after 130° C./1 hr in nitrogen condition. Results are summarized in Table 3.

TABLE 3

| | Catalyst | Cross Linker | | |
|---|---|---|---|---|
| Example No. | (loading) | (loading) | Dₖ | D_{f} |
| Example 3A | LiFABA (2 pphr) | — | 2.40 | 0.0014 |
| Example 3B | NACURE-1419 (3 pphr) | — | 2.28 | 0.0014 |
| Example 3C | LiFABA (2 pphr) | EpNBCHEp | 2.27 | 0.0021 |
| | | (6.5 pphr) | | |
| Example 3D | NACURE-1419 (1 pphr) | EpNBCHEp | 2.41 | 0.0014 |
| | | (2.5 pphr) | | |

pphr—parts per hundred parts resin by weight, i.e., terpolymer

### Examples 4-4D PG

### Low Loss Properties of Cured Films of Terpolymer and Various Epoxy Crosslinkers

A terpolymer, PENB/HexNB/CHEpNB (70/22.5/7.5 mole ratio) as set forth in Polymer Example 4 was dissolved in mesitylene to prepare 25 wt. % solution. NACURE-1419 catalyst was dissolved in mesitylene to deliver the thermal acid generator to the polymer solution at 3 pphr loading. The epoxy cross linkers as summarized in Table 4 were also added in 5 pphr loading to Examples 4B, 4C and 4D. The polymer solutions containing thermal acid catalyst and epoxy cross linkers were doctor bladed on glass substrates and heated to 130° C. for 1 hour in an oven under nitrogen atmosphere to remove the solvent. The films after this step were fully soluble in THF. The films obtained were fully cured at 180° C. for 1 hour in an oven under nitrogen atmosphere to obtain films that were not soluble in THF. The dielectric properties of the films obtained at 90-140 μm thicknesses were determined at 10 GHz before and after cure. The results are summarized in Table 4.

TABLE 4

| | | Dₖ | D_{f} |
|---|---|---|---|
| Example No. | Cross Linker | (after cure) | (after cure) |
| Example 4A | — | 2.26 | 0.0013 |
| Example 4B | EpNBCHEp | 2.34 | 0.0014 |
| Example 4C | EpVNBEp | 2.31 | 0.0013 |
| Example 4D | EpCyOcEp | 2.43 | 0.0013 |

### Examples 5A-5B and Comparative Examples 1A-1B

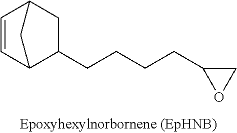 [SMILES: C1=CC2CC1CC2CCCCC1CO1]

A monomer mixture was prepared using PENB (13.13 g, 66.3 mmol) and HexNB (2.95 g, 16.6 mmol) at an 80/20 molar ratio. Epoxyhexylnorbornene (EpHNB) was used as an epoxy monomer in Comparative Examples 1A and 1B. CHEpNB was used as the epoxy monomer in Examples 5B and 5C at 2.5 pphr and 5 pphr loading respectively as also summarized in Table 5. No epoxy monomer was used in Example 5A. Pd680 catalyst, UV-CATA co-catalyst and ITX sensitizer were added to the monomer mixtures at monomer:Pd680:ITX:UV-CATA at 10000:1:2:2 molar ratio. These mixtures were spread on glass substrates to prepare thin layers and exposed to UV radiation to cure the samples to generate thin films. Dielectric constants (Dk) measured for the samples in Examples 5A-5C were in 2.5-2.54 range at 10 GHz. The dielectric dissipation factor (Df) values were measured at 10 GHz and are listed in Table 5. A comparative plot of Df with the level of loadings of the epoxy monomers is shown in the drawing. It is clear from the drawing that the addition of EpHNB monomer exponentially increase the Df value at higher levels of EpHNB and therefore it is not suitable for low loss applications since the Df values were significantly increased. On the other hand, use of CHEpNB as the epoxy monomer has no significant changes in the Df values at similar levels thus offering significant advantages in the fabrication of low loss materials as disclosed herein.

### Examples 6A-6C

CHEpNB monomer was added at 10 pphr (Example 6B) and 20 pphr (Example 6C) loadings to HexNB monomer to prepare the monomer mixtures. No epoxy monomer was added in Example 6A. Pd680 catalyst, UV-CATA co-catalyst and ITX sensitizer were added to the monomer mixtures at monomer:Pd680:ITX:UV-CATA at 10000:1:2:2 molar ratio. These mixtures were spread on glass substrates to prepare thin layers and exposed to UV radiation to cure the samples to generate thin films. Dielectric constants measured for the samples in Examples 6A-6C were in 2.34-2.35 range at 10 GHz. The Df values measured at 10 GHz are also summarized in Table 5 as well as shown graphically in the drawing. The drawing shows the Df values at various loadings of CHEpNB. The drawing again shows the superior low loss property of the composition of this invention where CHEpNB has no significant variation in Df values whereas addition of EpHNB monomer is not suitable for low loss applications since Df values were significantly increased.

TABLE 5

| | | Epoxy Monomer | Df at 10 |
|---|---|---|---|
| Example No. | Polymer | (pphr) | GHz |
| Comp. Ex. 1A | PENB/HexNB/EpHNB | EpHNB (2.5 pphr) | 0.0042 |
| Comp. Ex. 1B | PENB/HexNB/EpHNB | EpHNB (5 pphr) | 0.0076 |
| Example 5A | PENB/HexNB | — | 0.0007 |
| Example 5B | PENB/HexNB/CHEpNB | CHEpNB (2.5 pphr) | 0.0008 |
| Example 5C | PENB/HexNB/CHEpNB | CHEpNB (5 pphr) | 0.0008 |
| Example 6A | HexNB | — | 0.0004 |
| Example 6B | HexNB/CHEpNB | CHEpNB (10 pphr) | 0.0006 |
| Example 6C | HexNB/CHEpNB | CHEpNB (20 pphr) | 0.0007 |

### Examples 7A-7D

### Flame Retardant Compositions

High molecular weight terpolymer, NB/PENB/CyHexeneNB (60/19/21 mole ratio), as set forth in Polymer Example 3 was mixed with the low molecular weight terpolymer, NB/VNB/CHEpNB (73/16/11 mole ratio), as set forth in Polymer Example 1 or the terpolymer, NB/VNB/CHEpNB (78/16/6 mole ratio) as set forth in Polymer Example 2 were mixed at 70:30 weight ratio and dissolved in toluene to prepare 30 wt. % polymer solution. Various formulation additives were dissolved in these polymer solutions as summarized in Table 6. The flame-retardant package (FR Package) was prepared my mixing melamine (74 wt. %), SV2300-SVJ silica nano particles (23 wt. %) and ferric oxide-2 (3 wt. %) and grinding the mixture in a high-speed grinder for about 3 minutes. This flame-retardant package was added to the formulations as listed in Table 6 and rolled overnight to prepare the flame-retardant compositions.

Cured samples from the flame-retardant compositions of Examples 7A-7D were prepared with or without glass cloth. The compositions were doctor bladed (40-mil) on polyimide films and the solvent was removed by heating at 110° C. for 1 hour in an oven under nitrogen atmosphere. The B-staged samples were cured in a heated Press at 3 MPa by heating to 150° C. for 30 minutes and then at 200° C. for 90 minutes. TMA and TGA analysis were performed to determine CTE, T_{g} and T_{d5} of the cured samples. The results for flame-retardant compositions of Examples 7A and 7B are listed in Table 7 and for flame-retardant compositions of Examples 7C and 7D are listed in Table 8.

TABLE 6

| | Example | Example | Example | Example |
|---|---|---|---|---|
| Example No. | 7A | 7B | 7C | 7D |
| High Mw (70%) | 3 | 3 | 3 | 3 |
| Low Mw (30%) | 2 | 1 | 2 | 1 |
| B1000 (pphr) | — | — | 22.5 | 22.5 |
| TAIC (pphr) | — | — | 10 | 10 |
| DCP (pphr) | 2.5 | 2.5 | 3 | 3 |
| Irganox-1076 (pphr) | — | — | 1.75 | 1.75 |
| Irgafos-168 (pphr) | — | — | 0.75 | 0.75 |
| 1-Vinylimidazole (pphr) | — | — | 3 | 3 |
| NACURE-1419 (pphr) | 2.5 | 2.5 | 3 | 3 |
| FR Package (pphr) | 150 | 150 | 180 | 180 |

Glass cloth composites for Dₖ and D_{f} measurements at 10 GHz, TMA for CTE and DMA for glass transition temperature (T_{g}) were prepared by placing a low loss glass cloth on a polyimide film, doctor blading (10 mil) the flame-retardant compositions on the glass cloth and removing part of the solvent by heating to 110° C. in an oven under nitrogen atmosphere for about 15 minutes. The glass cloth coated on one side were taken out of the oven, turned on the other side and the flame-retardant compositions were doctor bladed (10 mil) on the glass cloth and fully removed the solvent by heating to 110° C. in an oven under nitrogen atmosphere for about 45 minutes. The B-staged samples were cured in a heated Press at 5 MPa by heating to 150° C. for 30 minutes and then at 200° C. for 90 minutes to obtain glass cloth composites at about 100 μm thickness. The results for flame-retardant compositions of Examples 7A and 7B are listed in Table 7 and for flame-retardant compositions of Examples 7C and 7D are listed in Table 8.

Glass cloth composites for flame test measurements were prepared by placing a low loss glass cloth on a polyimide film, doctor blading (15 mil) the flame-retardant compositions on the glass cloth and removing part of the solvent by heating to 110° C. in an oven under nitrogen atmosphere for 15 minutes. The glass cloth coated on one side were taken out of the oven, turned on the other side and the flame-retardant dispersions were doctor bladed (15 mil) on the glass cloth and fully removed the solvent by heating to 110° C. in an oven under nitrogen atmosphere for about 45 minutes. The B-staged samples were cut into six rectangular pieces of 1 cm×10 cm and cured in a heated Press at 5 MPa by heating to 150° C. for 30 minutes and then at 200° C. for 90 minutes. The results for flame-retardant compositions of Examples 7A and 7B are listed in Table 7 and for flame-retardant compositions of Examples 7C and 7D are listed in Table 8.

TABLE 7

| Example No. | Example 7A | Example 7B |
|---|---|---|
| Glass cloth | Yes | Yes |
| FT for Dk/Df, μm | 90 | 90 |
| Dk @ 10 GHz | 3.26 | 3.29 |
| Df @ 10 GHz | 0.0026 | 0.0023 |
| After flame t₁ | 0, 0 | 0, 0 |
| After flame t₂ | 0, 0 | 2, 0 |
| UL94 rating | V0 (2) | V0 (2) |

TABLE 8

| Example No. | Example 7C | Example 7D | Example 7C | Example 7D |
|---|---|---|---|---|
| Glass cloth | No | No | Yes | Yes |
| CTE (TMA) | 69 ppm/K | 53 ppm/K | 13 ppm/K | 11 ppm/K |
| T_{g} (TMA), ° C. | 200 | 220 | — | — |
| T_{g} (DMA), ° C. | — | — | 256 | 265 |
| T_{d5} (TGA), ° C. | 273 | 273 | — | — |
| FT for Dk/Df, μm | — | — | 115 | 110 |
| Dk @ 10 GHz | — | — | 3.12 | 3.09 |
| Df @ 10 GHz | — | — | 0.0019 | 0.0018 |
| After flame t₁ | — | — | 0, 0, 0, 0 | 1,0 |
| After flame t₂ | — | — | 0, 2, 2, 4 | 3, 3 |
| UL94 rating | — | — | V0 (4) | V0 (2) |

### Comparative Examples 2A-2B

Low Loss Properties of Terpolymer with CHEpCOOCH₂CHEp

A terpolymer, PENB/HexNB/CHEpNB (70/22.5/7.5 mole ratio), as set forth in Polymer Example 4 was dissolved in mesitylene to prepare 25 wt. % solution. NACURE-1419 catalyst was dissolved in mesitylene to deliver this thermal acid generator to the polymer solution at 1 pphr loading. The CHEpCOOCH2CHEp epoxy cross linker was also added in 5 pphr (Comparative Example 2A) or 10 pphr (Comparative Example 2B) loadings. The polymer solutions containing thermal acid catalyst and epoxy cross linker were doctor bladed on glass substrates and heated to 130° C. for 1 hour in an oven under nitrogen atmosphere to remove the solvent. The films obtained were fully cured at 180° C. for 1 hour in an oven under nitrogen atmosphere The dielectric properties of the films were determined at 10 GHz before and after cure and listed in Table 9. The Df values were significantly higher for these Comparative Examples 2A and 2B suggesting a polar linkers such as esters are not suitable for epoxy cross linkers in low loss applications.

TABLE 9

| | Dₖ | D_{f} | Dₖ | D_{f} |
|---|---|---|---|---|
| Example No. | (before cure) | (before cure) | (after cure) | (after cure) |
| Comp. Ex. 2A | 2.67 | 0.0064 | 2.33 | 0.0030 |
| Comp. Ex. 2B | 2.39 | 0.0078 | 2.39 | 0.0088 |

Although the invention has been illustrated by certain of the preceding examples, it is not to be construed as being limited thereby; but rather, the invention encompasses the generic area as hereinbefore disclosed. Various modifications and embodiments can be made without departing from the spirit and scope thereof.

What is claimed is:

1. A polymer comprising:
a) at least one first repeating unit represented by formula (IA), said first repeating unit is derived from a monomer of formula (I): 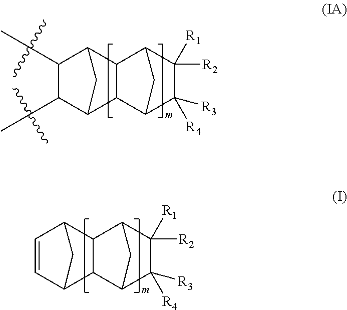
wherein: [symbol]
denotes a place of bonding with another repeat unit;
m is an integer 0, 1 or 2;
wherein at least one of R₁, R₂, R₃ and R₄ contains an epoxy group chosen from epoxy, —CH₂epoxy, epoxy(C₃-C₁₀)cycloalkyl, epoxy(C₆-C₁₂)bicycloalkyl, epoxy(C₆-C₁₂)aryl and epoxy(C₆-C₁₂)aryl(C₁-C₆)alkyl;
the remaining R₁, R₂, R₃ and R₄ are the same or different and each independently chosen from hydrogen, methyl, ethyl, linear or branched (C₃-C₁₆)alkyl, (C₃-C₁₀)cycloalkyl, (C₆-C₁₂)bicycloalkyl, (C₆-C₁₂)aryl and (C₆-C₁₂)aryl(C₁-C₆)alkyl; or
one of R₁ and R₂ taken together with one of R₃ and R₄ and the carbon atoms to which they are attached to form a substituted or unsubstituted (C₅-C₁₄)cyclic, (C₅-C₁₄)bicyclic or (C₅-C₁₄)tricyclic ring; and
b) at least one second repeating unit represented by formula (IIA), said second repeating unit is derived from a monomer of formula (II): 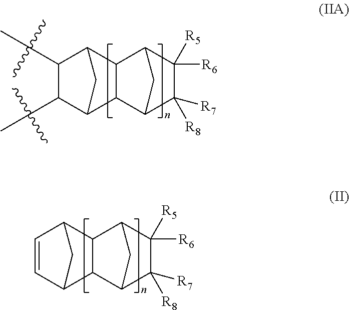
wherein: [symbol]
denotes a place of bonding with another repeat unit;
n is an integer 0, 1 or 2;
R₅, R₆, R₇ and R₈ are the same or different and each independently chosen from hydrogen, methyl, ethyl, linear or branched (C₃-C₁₆)alkyl, (C₃-C₁₀)cycloalkyl, (C₆-C₁₂)bicycloalkyl, (C₆-C₁₂)aryl and (C₆-C₁₂)aryl(C₁-C₆)alkyl; or
one of R₅ and R₆ taken together with one of R₇ and R₈ and the carbon atoms to which they are attached to form a substituted or unsubstituted (C₅-C₁₄)cyclic, (C₅-C₁₄)bicyclic or (C₅-C₁₄)tricyclic ring; and
c) optionally a third repeating unit represented by formula (IIIA), said third repeating unit is derived from a monomer of formula (III): 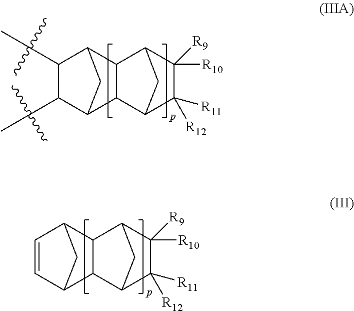
wherein: [symbol]
denotes a place of bonding with another repeat unit;
p is an integer 0, 1 or 2;
at least one of R₉, R₁₀, R₁₁ and R₁₂ is selected from the group consisting of methylidene, ethylidene, vinyl, linear or branched (C₃-C₁₆)alkenyl, (C₃-C₁₀)cycloalkenyl, (C₆-C₁₂)bicycloalkenyl and (C₆-C₁₂)aryl(C₂-C₁₆)alkenyl and the remaining R₉, R₁₀, R₁₁ and R₁₂ are the same or different and each independently selected from the group consisting of hydrogen, methyl, ethyl, linear or branched (C₃-C₁₆)alkyl, (C₃-C₁₀)cycloalkyl, (C₆-C₁₂)bicycloalkyl, (C₆-C₁₂)aryl and (C₆-C₁₂)aryl(C₁-C₆)alkyl; or
one of R₉ and R₁₀ taken together with one of R₁₁ and R₁₂ and the carbon atoms to which they are attached to form a substituted or unsubstituted (C₅-C₁₄)cyclic, (C₅-C₁₄)bicyclic or (C₅-C₁₄)tricyclic ring containing at least one double bond; and
wherein the first repeat unit is present at an amount from five mole percent to thirty mole percent based on total moles of first, second and third repeat units.

2. The polymer according to claim 1, wherein
m is 0 or 1;
n is 0 or 1;
wherein at least one of R₁, R₂, R₃ and R₄ is chosen from epoxy, —CH₂epoxy, cyclopentylepoxy and cyclohexylepoxy;
the remaining R₁, R₂, R₃ and R₄ are the same or different and each independently chosen from hydrogen, methyl, ethyl, n-propyl, n-butyl, n-hexyl, cyclopentyl, cyclohexyl and norbornyl; or
one of R₁ and R₂ taken together with one of R₃ and R₄ and the carbon atoms to which they are attached to form a cyclopentyl, cyclohexyl, cycloheptyl, bicycloheptyl, bicyclooctyl, or adamantyl ring; and
R₅, R₆, R₇ and R₈ are the same or different and each independently selected from the group consisting of hydrogen, methyl, ethyl, n-propyl, n-butyl, n-hexyl, n-octyl, n-decyl, cyclopentyl, cyclohexyl, norbornyl, phenyl and phenethyl; or
one of R₅ and R₆ taken together with one of R₇ and R₈ and the carbon atoms to which they are attached to form a cyclopentenyl, cyclohexenyl, cycloheptenyl, bicycloheptenyl or bicyclooctenyl ring.

3. The polymer according to claim 1, wherein the monomer of formula (I) is chosen from:

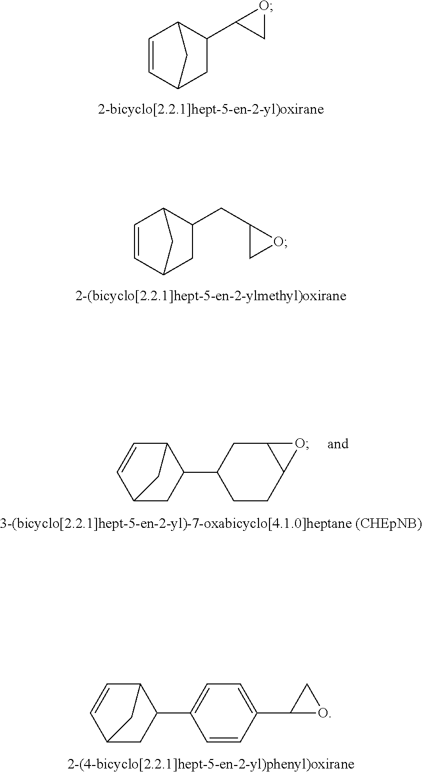 [SMILES: C1=CC2CC1CC2C1CO1 ; C1=CC2CC1CC2CC1CO1 ; C1=CC2CC1CC2C1CCC2OC2C1 ; C1=CC2CC1CC2c1ccc(C2CO2)cc1]

4. The polymer according to claim 1, wherein the monomer of formula (II) is chosen from:

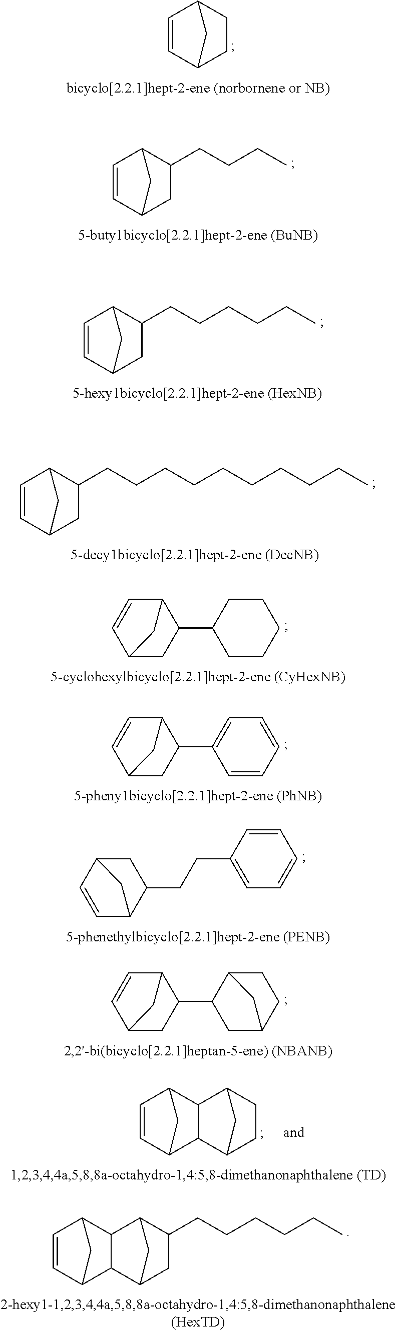

5. The polymer according to claim 1, wherein the monomer of formula (III) is chosen from:

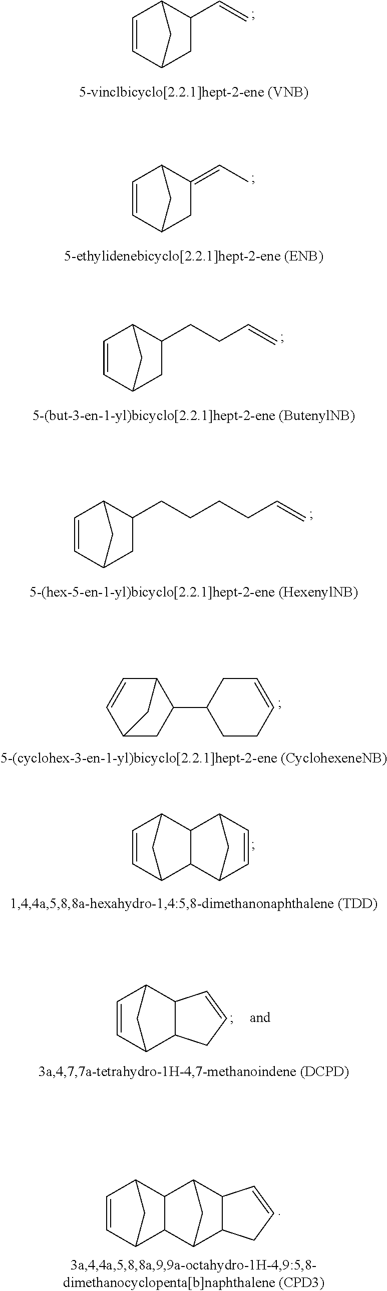

6. The polymer according to claim 1, wherein the first repeat unit is present at an amount in the range from ten mole percent to twenty mole percent based on total moles of first, second and third repeat units.

7. The polymer according to claim 1, which is selected from the group consisting of:
a terpolymer of norbornene (NB), 5-vinylbicyclo[2.2.1]hept-2-ene (VNB) and 3-(bicyclo[2.2.1]hept-5-en-2-yl)-7-oxabicyclo[4.1.0]heptane (CHEpNB);
a terpolymer of norbornene (NB), 5-(but-3-en-1-yl)bicyclo[2.2.1]hept-2-ene (ButenylNB) and 3-(bicyclo[2.2.1]hept-5-en-2-yl)-7-oxabicyclo[4.1.0]heptane (CHEpNB);
a terpolymer of 5-hexylbicyclo[2.2.1]hept-2-ene (HexNB), 5-(hex-5-en-1-yl)bicyclo[2.2.1]hept-2-ene (HexenylNB) and 3-(bicyclo[2.2.1]hept-5-en-2-yl)-7-oxabicyclo[4.1.0]heptane (CHEpNB);
a terpolymer of 5-phenethylbicyclo[2.2.1]hept-2-ene (PENB), 5-hexylbicyclo[2.2.1]hept-2-ene (HexNB) and 3.(bicyclo[2.2.1]hept-5-en-2-yl)-7-oxabicyclo[4.1.0]heptane (CHEpNB); and
a terpolymer of 5-hexylbicyclo[2.2.1]hept-2-ene (HexNB), 5-cyclohex-3-en-1-yl)bicyclo[2.2.1]hept-2-ene (CyclohexeneNB) and 2-(bicyclo[2.2.1]hept-5-en-2-yl)oxirane.

8. A composition comprising:
a) a polymer comprising:
i) at least one first repeating unit represented by formula (IA), said first repeating unit is derived from a monomer of formula (I): 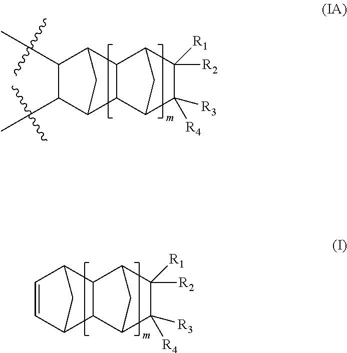
wherein: [symbol]
denotes a place of bonding with another repeat unit;
m is an integer 0, 1 or 2;
wherein at least one of R₁, R₂, R₃ and R₄ contains an epoxy group chosen from epoxy, —CH₂epoxy, epoxy(C₃-C₁₀)cycloalkyl, epoxy(C₆-C₁₂)bicycloalkyl, epoxy(C₆-C₁₂)aryl and epoxy(C₆-C₁₂)aryl(C₁-C₆)alkyl;
the remaining R₁, R₂, R₃ and R₄ are the same or different and each independently chosen from hydrogen, methyl, ethyl, linear or branched (C₃-C₁₆)alkyl, (C₃-C₁₀)cycloalkyl, (C₆-C₁₂)bicycloalkyl, (C₆-C₁₂)aryl and (C₆-C₁₂)aryl(C₁-C₆)alkyl; or
one of R₁ and R₂ taken together with one of R₃ and R₄ and the carbon atoms to which they are attached to form a substituted or unsubstituted (C₅-C₁₄)cyclic, (C₅-C₁₄)bicyclic or (C₅-C₁₄)tricyclic ring; and
ii) at least one second repeating unit represented by formula (IIA), said second repeating unit is derived from a monomer of formula (II): 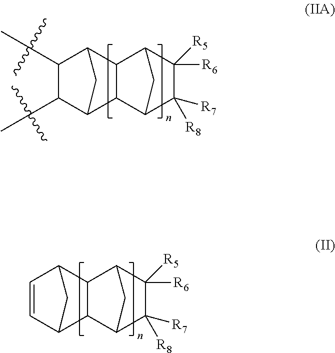
wherein: [symbol]
denotes a place of bonding with another repeat unit;
n is an integer 0, 1 or 2;
R₅, R₆, R₇ and R₈ are the same or different and each independently chosen from hydrogen, methyl, ethyl, linear or branched (C₃-C₁₆)alkyl, (C₃-C₁₀)cycloalkyl, (C₆-C₁₂)bicycloalkyl, (C₆-C₁₂)aryl and (C₆-C₁₂)aryl(C₁-C₆)alkyl; or
one of R₅ and R₆ taken together with one of R₇ and R₈ and the carbon atoms to which they are attached to form a substituted or unsubstituted (C₅-C₁₄)cyclic, (C₅-C₁₄)bicyclic or (C₅-C₁₄)tricyclic ring; and
iii) optionally a third repeating unit represented by formula (IIIA), said third repeating unit is derived from a monomer of formula (III): 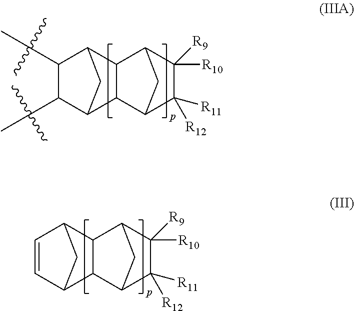
wherein: [symbol]
denotes a place of bonding with another repeat unit;
p is an integer 0, 1 or 2;
at least one of R₉, R₁₀, R₁₁ and R₁₂ is selected from the group consisting of methylidene, ethylidene, vinyl, linear or branched (C₃-C₁₆)alkenyl, (C₃-C₁₀)cycloalkenyl, (C₆-C₁₂)bicycloalkenyl and (C₆-C₁₂)aryl(C₂-C₁₆)alkenyl and the remaining R₉, R₁₀, R₁₁ and R₁₂ are the same or different and each independently selected from the group consisting of hydrogen, methyl, ethyl, linear or branched (C₃-C₁₆)alkyl, (C₃-C₁₀)cycloalkyl, (C₆-C₁₂)bicycloalkyl, (C₆-C₁₂)aryl and (C₆-C₁₂)aryl(C₁-C₆)alkyl; or
one of R₉ and R₁₀ taken together with one of R₁ and R₁₂ and the carbon atoms to which they are attached to form a substituted or unsubstituted (C₅-C₁₄)cyclic, (C₅-C₁₄)bicyclic or (C₅-C₁₄)tricyclic ring containing at least one double bond;
wherein the first repeat unit is present at an amount not less than five mole percent based on total moles of first and second repeat units; and
b) one or more of an epoxy compound chosen from: 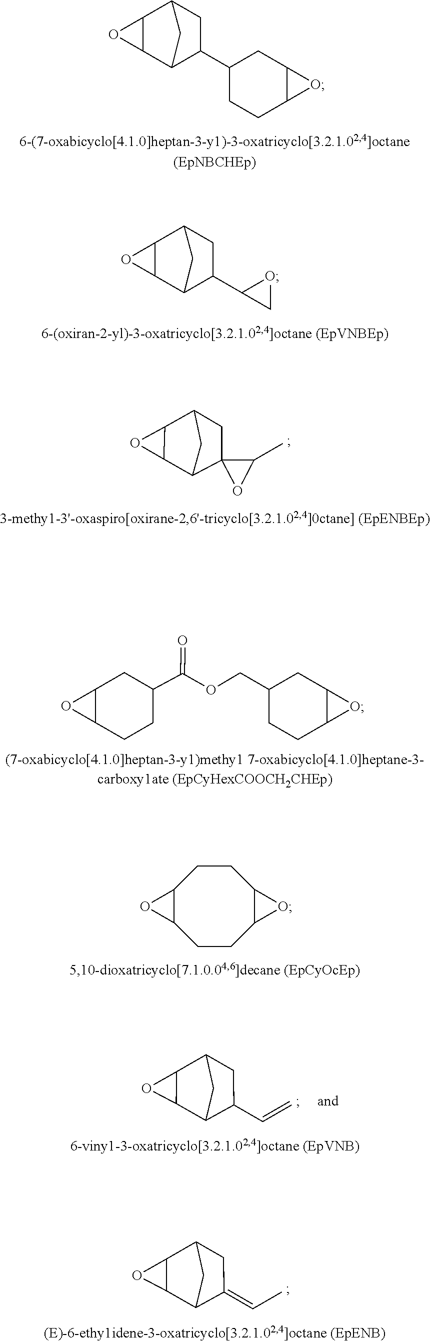
d) one or more additives chosen from a thermal acid generator or a free radical initiator.

9. The composition according to claim 8, wherein the first repeat unit of the polymer is derived from the monomer of formula (I) selected from the group consisting of:

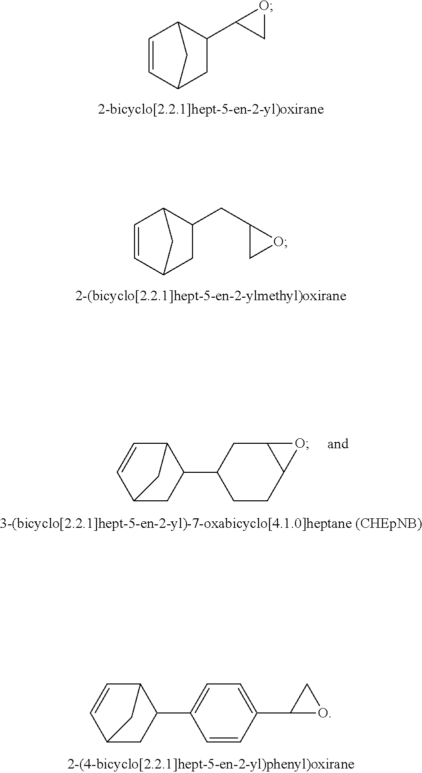

10. The composition according to claim 8, wherein the second repeat unit of the polymer is derived from the monomer of formula (II) selected from the group consisting of

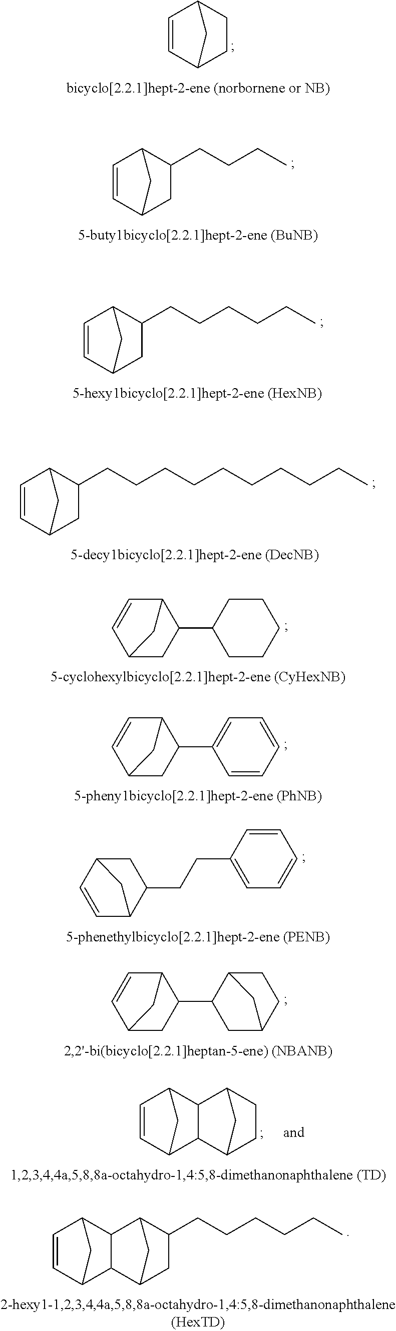

11. The composition according to claim 11, wherein the third repeat unit of the polymer is derived from the monomer of formula (III) selected from the group consisting of

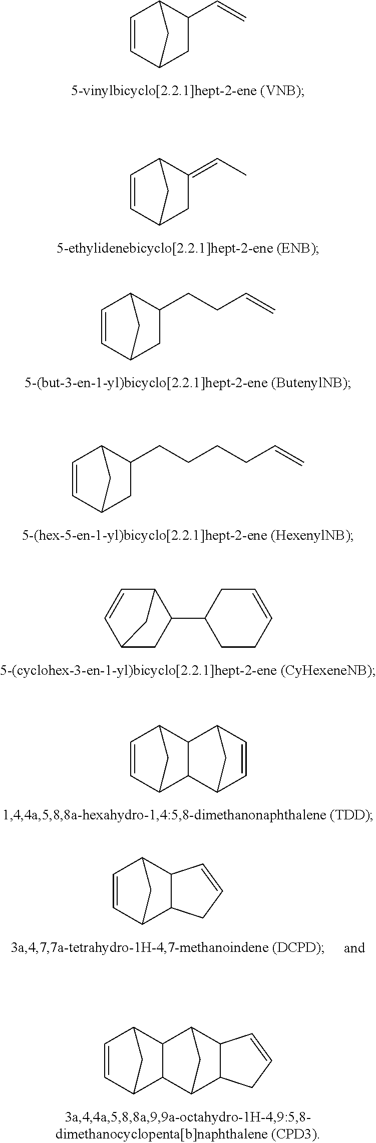

12. The composition according to claim 8 further comprising a crosslinking agent selected from the group consisting of:

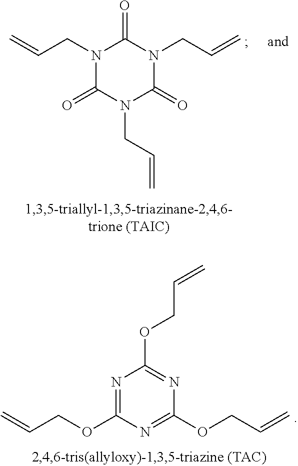

13. The composition according to claim 8 further comprising a tackifier selected from the group consisting of:

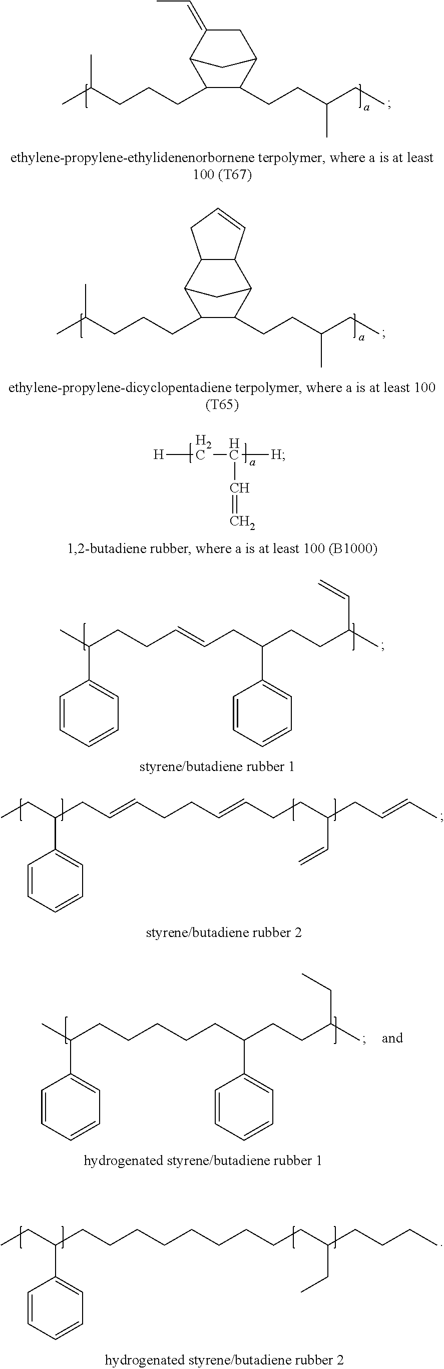

14. The composition according to claim 8, wherein the thermal acid generator is selected from the group consisting of: 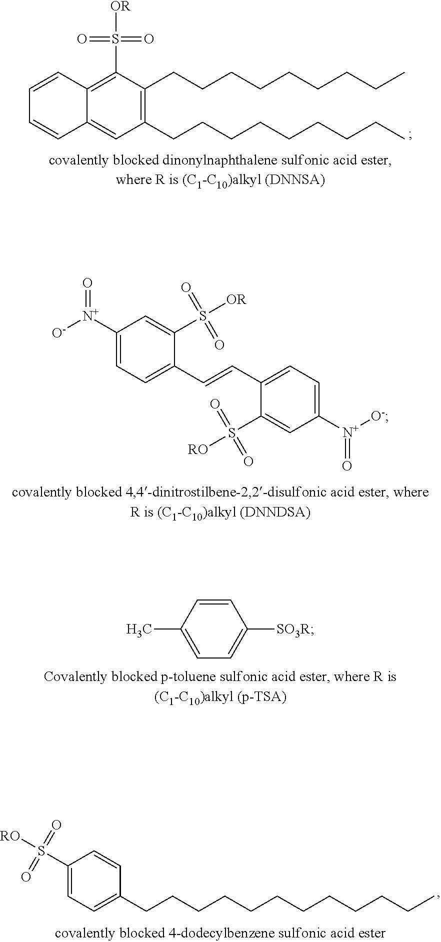
where R is (C₁-C₁₀)alkyl (p-TSA) (DDBSA); and
lithium tetrakis(pentafluorophenyl)borate diethyl etherate (LiFABA).

15. The composition according to claim 8, which is selected from the group consisting of:
a solution containing a mixture of a terpolymer of 5-phenethylbicyclo[2.2.1]hept-2-ene (PENB), 5-hexylbicyclo[2.2.1]hept-2-ene (HexNB) and 3.(bicyclo[2.2.1]hept-5-en-2-yl)-7-oxabicyclo[4.1.0]heptane (CHEpNB); covalently blocked dinonylnaphthalene sulfonic acid (DNNSA), and 6-(7-oxabicyclo[4.1.0]heptan-3-yl)-3-oxatricyclo[3.2.1.0^{2,4}]octane (EpNBCHEp);
a solution containing a mixture of a terpolymer of 5-phenethylbicyclo[2.2.1]hept-2-ene (PENB), 5-hexylbicyclo[2.2.1]hept-2-ene (HexNB) and 3.(bicyclo[2.2.1]hept-5-en-2-yl)-7-oxabicyclo[4.1.0]heptane (CHEpNB); covalently blocked dinonylnaphthalene sulfonic acid (DNNSA), 6-(7-oxabicyclo[4.1.0]heptan-3-yl)-3-oxatricyclo[3.2.1.0^{2,4}]octane (EpNBCHEp) and lithium tetrakis(pentafluorophenyl)borate diethyl etherate (LiFABA);
a solution containing a mixture of a terpolymer of 5-phenethylbicyclo[2.2.1]hept-2-ene (PENB), 5-hexylbicyclo[2.2.1]hept-2-ene (HexNB) and 3.(bicyclo[2.2.1]hept-5-en-2-yl)-7-oxabicyclo[4.1.0]heptane (CHEpNB); covalently blocked dinonylnaphthalene sulfonic acid (DNNSA) and 6-(oxiran-2-yl)-3-oxatricyclo[3.2.1.0^{2,4}]octane (EpVNBEp); and
a solution containing a mixture of a terpolymer of 5-phenethylbicyclo[2.2.1]hept-2-ene (PENB), 5-hexylbicyclo[2.2.1]hept-2-ene (HexNB) and 3.(bicyclo[2.2.1]hept-5-en-2-yl)-7-oxabicyclo[4.1.0]heptane (CHEpNB); covalently blocked dinonylnaphthalene sulfonic acid (DNNSA) and 5,10-dioxatricyclo[7.1.0.0^{4,6}]-decane (EpCyOcEp).

16. A film formed from the composition according to claim 8.

17. The film according to claim 16, which has a dielectric constant (Dk) less than 2.5 at a frequency of 10 GHz, a glass transition temperature higher than 300° C. and a coefficient of thermal expansion (CTE) less than 120 ppm/K.

18. The film according to claim 16, which is formed from a composition selected from the group consisting of:
a solution containing a mixture of a terpolymer of 5-phenethylbicyclo[2.2.1]hept-2-ene (PENB), 5-hexylbicyclo[2.2.1]hept-2-ene (HexNB) and 3.(bicyclo[2.2.1]hept-5-en-2-yl)-7-oxabicyclo[4.1.0]heptane (CHEpNB); covalently blocked dinonylnaphthalene sulfonic acid (DNNSA), and 6-(7-oxabicyclo[4.1.0]heptan-3-yl)-3-oxatricyclo[3.2.1.0^{2,4}]octane (EpNBCHEp);
a solution containing a mixture of a terpolymer of 5-phenethylbicyclo[2.2.1]hept-2-ene (PENB), 5-hexylbicyclo[2.2.1]hept-2-ene (HexNB) and 3.(bicyclo[2.2.1]hept-5-en-2-yl)-7-oxabicyclo[4.1.0]heptane (CHEpNB); covalently blocked dinonylnaphthalene sulfonic acid (DNNSA), 6-(7-oxabicyclo[4.1.0]heptan-3-yl)-3-oxatricyclo[3.2.1.0^{2,4}]octane (EpNBCHEp) and lithium tetrakis(pentafluorophenyl)borate diethyl etherate (LiFABA);
a solution containing a mixture of a terpolymer of 5-phenethylbicyclo[2.2.1]hept-2-ene (PENB), 5-hexylbicyclo[2.2.1]hept-2-ene (HexNB) and 3.(bicyclo[2.2.1]hept-5-en-2-yl)-7-oxabicyclo[4.1.0]heptane (CHEpNB); covalently blocked dinonylnaphthalene sulfonic acid (DNNSA) and 6-(oxiran-2-yl)-3-oxatricyclo[3.2.1.0^{2,4}]octane (EpVNBEp); and
a solution containing a mixture of a terpolymer of 5-phenethylbicyclo[2.2.1]hept-2-ene (PENB), 5-hexylbicyclo[2.2.1]hept-2-ene (HexNB) and 3.(bicyclo[2.2.1]hept-5-en-2-yl)-7-oxabicyclo[4.1.0]heptane (CHEpNB); covalently blocked dinonylnaphthalene sulfonic acid (DNNSA) and 5,10-dioxatricyclo[7.1.0.0^{4,6}]-decane (EpCyOcEp).

19. A glass composite film formed from the polymer of claim 1.

20. A glass composite film formed from the composition of claim 8.
